(19) United States
(12) Patent Application Publication
(10) Pub. No.: US 2012/0109854 A1
(43) Pub. Date: May 3, 2012

(54) CHECK FRAUD PROTECTION SYSTEMS AND METHODS

(75) Inventors: Maria G. Thomas, San Francisco, CA (US); Michael J. Tretola, Concord, CA (US); Karen J. Barson, San Mateo, CA (US); Arien C. Ferrell, Sunnyvale, CA (US)

(73) Assignee: INTUIT INC., Mountain View, CA (US)

(21) Appl. No.: 12/917,377

(22) Filed: Nov. 1, 2010

(51) Int. Cl. G06Q 90/00

(52) U.S. Cl. 705/500

(57) ABSTRACT

Check fraud protection method in which a customer is automatically enrolled in a check fraud protection service without separately subscribing to the service. In the event of fraudulent activity, the customer requests reimbursement from the financial institution and retains the exclusive right of recovery from a financial institution. The check fraud service provider serves as an advisor to the customer who retains exclusive right of recovery at all times. If customer is not fully compensated by the financial institution, the difference is paid to the customer by the check fraud protection service provider or insurer thereof, and new checks for a new checking account are provided to the customer free of charge.

### BACKGROUND

Check fraud is a significant problem for banks and account holders including individual and business customers who suffer financial losses due to check fraud, examples of which include check alteration, counterfeit checks and forged signatures and endorsements. The magnitude of this problem is demonstrated by estimates that fraudulent activities result in billions of dollars of financial losses each year. It is widely believed that businesses are popular targets of check fraud professionals, and payroll and business checks are popular targets for fraud by counterfeiting and alteration.

Account holders may learn of check fraud involving their accounts by being notified by a financial institution or when reviewing transactions on the accounts. Upon learning of the fraud, account holders try to work with the financial institution to be reimbursed for the financial loss. Account holders, however, are often not sophisticated with regard to procedures, timelines and deadlines for seeking reimbursement from a financial institution for financial losses resulting from fraudulent activity. Further complications arise from potential confusion and complexities of determining which laws or rules apply and which party bears responsibility for fraudulent activities. For example, the Uniform Commercial Code (UCC) and related regulations may impart certain responsibilities upon businesses for check fraud. Thus, if a bank offers their customer check stock that contains security features that could have prevented a specific case of fraud, the bank may claim that the customer was negligent and, thus is at least partially liable for loss resulting from the fraudulent activity to preclude or limit reimbursement to the customer.

Consequently, reimbursement claims are often not pursued, and the process can be complicated and beyond account holder knowledge. Further, for account holders who do go through the process, the process can be frustrating and time consuming, and the result achieved by an account holder may not be the best result that could be achieved given the circumstances.

Certain known methods for providing protection against certain types of check fraud are optional in that in order for account holders to receive these benefits, they are required to separately enroll in or subscribe to the service and pay an additional fee for the service. Consequently, many account holders forgo such protection and if they are victims of check fraud, their options for recovery of funds may be limited. Further, account holders may be skeptical of offers presented by financial institutions since they may not understand the details or may not fully understand the potential benefits for costs of the additional, optional service.

Additionally, certain known methods are limited to the account holder executing a particular type of power of attorney form to assign any right of recovery from the account holder's bank to a third party such as a check printer or service provider, and then the third party pursues the claim. Thus, upon executing the power of attorney, the account holder is stripped of recovery rights and is no longer involved in the process. Such methods, however, have the potential to short change the account holder.

Moreover, certain known methods require the customer to execute a legal document with which the customer may not be familiar. As such, the customer may blindly sign the document or do so with a limited understanding of the legal implications of the document, or spend additional money on an attorney to review the power of attorney that will be executed. Thus, enrolling in known fraud protection services may not only require the additional fee, but also additional time and legal costs to review and understand the power of attorney being signed.

Thus, methods relying on customers to pursue their own claims and methods involving fraud protection requiring separate enrollment, additional fees and assignment of rights of recovery to check printers and service providers are not desirable for various reasons.

### SUMMARY

According to one embodiment, a check fraud protection method comprises receiving an order to print checks for an account holder or customer that has a first checking account at a financial institution. The method further comprises printing checks for the first checking account per the order and enrolling checks of the order into a check fraud protection service. The method further comprises receiving a claim from the customer requesting reimbursement or compensation for fraudulent activity involving a check printed per the order and determining whether the check is covered by the check fraud protection service. According to embodiments, enrollment determinations are made without having to refer to an enrollment or service indicator or indicia printed on the check. Instead, with embodiments, enrollment determinations are made based upon whether the subject check was printed or part of an order dated after the start date of the check fraud protection service or when the service was launched or began. In this manner, it is not necessary to print any enrollment indicator on any check covered by the check fraud protection service.

If the check is covered by the service, the customer is fully or partially reimbursed, or not reimbursed, by the financial institution, and any difference between a first amount of the lesser of the check fraud protection program coverage amount and the financial loss, and a second amount of what the financial institution paid the customer, is paid to the customer by a third party, i.e., by someone other than the financial institution.

According to a further embodiment, a check fraud protection method comprises receiving an order to print checks for a customer who has a first checking account at a financial institution and printing checks for the first checking account per the order. The method further comprises automatically enrolling the order of printed checks into a check fraud protection service. Under the check fraud protection service, each check of the order is covered or enrolled in the service without requiring the customer to separately subscribe to the service or pay an additional fee relative to a cost of the ordered checks. Further, according to embodiments, no enrollment indicator or indicia printed on the check is used to determine whether the check is covered by the check fraud protection service. Instead, with embodiments, whether a check is covered by the service is made based upon whether the subject check was ordered or printed after the check fraud protection service was launched or began such that it is not necessary to print any enrollment indicator on any enrolled check.

A further embodiment is directed to a check fraud protection method that considers whether the customer experienced financial loss such that reimbursement or compensation would involve payment to the customer or whether fraudulent activity did not result in financial loss such that the customer can be administratively put in a pre-fraud position by being provided with new checks for a new account at no charge to the customer. The method comprises receiving an order to print checks for a customer that has a first checking account at a financial institution, printing checks for the first checking account per the order and automatically enrolling checks of the order into a check fraud protection service. With automatic enrollment, the customer is not required to separately subscribe to or sign up for the fraud protection service. The method further comprises receiving a claim from customer for fraudulent activity involving a check that was printed per the order and determining whether the check is covered by the check fraud protection service. According to embodiments, no indicator or indicia printed on the check is used to determine whether the check is covered by or enrolled in the check fraud protection service. Instead, with embodiments, service coverage or enrollment determinations are made based upon whether the subject check was ordered or printed after the check fraud protection service was launched or began such that it is not necessary to print any enrollment indicator on any enrolled check. The method further comprises determining whether the fraudulent activity involved financial loss to the customer. If not, the first checking account is closed, a second checking account is opened, and new checks for the second checking account are printed at no charge to the customer. Further, the new checks for the second checking account are automatically enrolled into the check fraud protection service. If the fraudulent activity involved financial loss to the customer, then the method comprises assisting the customer with the claim and reimbursement or compensation from the financial institution while the customer retains the exclusive right of recovery from the financial institution at all times during claim processing until the claim is resolved.

Yet another embodiment is directed to a check fraud protection method that comprises receiving an order to print checks for a customer that has a first checking account at a financial institution and printing checks for the first checking account per the order. The order or printed checks is automatically enrolled into a fraud protection service such that each check of the order is covered by the fraud protection service without requiring the customer to separately subscribe to or enroll in the fraud protection service or pay an additional fee relative to a cost of the ordered checks. The method further comprises receiving a claim from the customer requesting reimbursement or compensation for fraudulent activity involving a check that was printed per the order, and determining whether the check is covered by the check fraud protection service. Embodiments do not utilize an enrollment indicator or indicia printed on the check to determine whether the check is covered by or enrolled in the check fraud protection service. Instead, with embodiments, the subject check is determined to be covered by the check fraud protection service if the checks were ordered or printed after the service was launched or began. In this manner, it is not necessary to print any enrollment indicator on any check covered by the service. If the check is covered, a determination is made whether the fraudulent activity involved financial loss to the customer. If not, the first checking account is closed, a second checking account is opened, and new checks are printed for the second checking account at no charge to the customer. The new checks are also automatically enrolled into the check fraud protection service. If there is financial loss, the method further comprises assisting the customer with the claim and reimbursement or compensation from the financial institution. During this process, the customer is not required to execute a power of attorney and retains the exclusive right of reimbursement from the financial institution at all times during claim processing. If the customer is not fully compensated by the financial institution, the customer can receive a payment in the amount of the difference between a first amount of the lesser of a maximum coverage amount and financial loss resulting from the fraudulent activity, and a second amount paid by the financial institution to the customer.

Yet another embodiment is directed to a check fraud protection method comprising receiving an order to print checks for a customer who has a first checking account at a financial institution and printing checks for the first checking account per the order. The printed checks are enrolled into a fraud protection service such that each check of the order is covered by the service without requiring the customer to separately subscribe to the fraud protection service. The method further comprises receiving a claim from the customer requesting reimbursement or compensation for fraudulent activity involving a check that was printed per the order and determining whether the check is covered by the check fraud protection service. According to embodiments, there is no enrollment indicator or indicia printed on the check to determine whether the check is covered or enrolled in the check fraud protection service. Rather, with embodiments, whether a check is covered by the check fraud protection service is based upon whether the order including the subject check was submitted or printed after the check fraud protection service was launched or began. If the check is covered, the method further comprises serving as an advisor or consultant to the customer to assist the customer in processing the claim and to be reimbursed directly by the financial institution. During this process, the customer retains the exclusive right of recovery from the financial institution, and no time does the advisor or consultant have any such rights.

Another embodiment is directed to a check fraud protection method comprising receiving an order to print checks for a customer that has a first checking account at a financial institution, printing checks for the first checking account per the order and automatically enrolling the order of printed checks into a fraud protection service. With embodiments, each check of the order is automatically covered by the fraud protection service without requiring the customer to separately subscribe to the fraud protection service. The method further comprises receiving a claim from the customer requesting reimbursement or compensation for fraudulent activity involving a check printed per the order, and determining whether the check is covered by the check fraud protection service based at least in part upon whether an identifier or indicator is printed on the check involved in the fraudulent activity. Embodiments do not use an indicator or indicia printed on the check to determine whether the check is covered or enrolled in the check fraud protection service. Instead, enrollment determinations are made based upon whether the subject check was printed or a date of the order including the subject check is after the check fraud protection service was launched or began such that it is not necessary to print any indicator on any enrolled check.

A further embodiment is directed to a check fraud protection method that comprises receiving an order to print checks for a customer that has a first checking account at a financial institution, printing checks for the first checking account per the order and automatically enrolling checks of the order into a check fraud protection service such that each check of the order being covered by the check fraud protection service without requiring the customer to separately subscribe to the fraud protection service. The method further comprises receiving a claim from the customer for reimbursement or compensation for fraudulent activity involving a check printed per the order, determining whether the check is covered by the check fraud protection service. According to embodiments, no indicator or indicia printed on the check is used to determine whether the check is covered or enrolled in the check fraud protection service. Instead, with embodiments, enrollment or coverage determinations are made based upon whether the check was printed or the order including the check was made after the check fraud protection service was launched or began such that it is not necessary to print any indicator on any enrolled check. If the check is enrolled or covered, the method further comprises determining whether the fraudulent activity involved financial loss to the customer. If there was no financial loss, the first checking account is closed, a second checking account is opened, and new checks for the second checking account are printed for the customer at no charge to the customer.

According to embodiments, each new check for the second checking account is automatically enrolled in the check fraud protection service. With embodiments, it is not necessary to print an indicator or other indicia on any check of the second checking account to indicate that checks of the second checking account are enrolled in the service. Instead, according to embodiments, determinations whether checks for the second checking account are covered by or enrolled within the check fraud protection service are made based upon whether the order of checks for the second checking account or the print date of the new checks was made after the check fraud protection service was launched or began.

Otherwise, if the fraudulent activity did involve financial loss to the customer, the method further comprises assisting the customer with the claim and reimbursement or compensation from the financial institution. During this process, the customer retains the exclusive right of recovery from the financial institution at all times during claim processing.

In accordance with another embodiment, a check fraud protection method comprises receiving an order to print checks for a customer who has a first checking account at a financial institution, printing checks for the first checking account per the order and enrolling the order of printed checks into a fraud protection service. According to embodiments, no enrolled check has an indictor or other indicial indicating enrollment in the service. Instead, according to embodiments, checks are automatically enrolled if the order or print date is after the date the service was launched or began such that it is not necessary to print any enrollment indicator on any enrolled check. Further, the customer is not required to separately subscribe to the fraud protection service. The method further comprises receiving a claim from the customer requesting reimbursement or compensation for fraudulent activity involving a check that was printed per the order and determining whether the check is covered by the check fraud protection service. According to embodiments, since there is no enrollment indicator or indicia printed on the check, enrollment determinations are made based upon whether the subject check or order including the check is dated after the date the check fraud protection service was launched or began. If the check is covered by the service, the method further comprises serving as an advisor or consultant to the customer to assist the customer in processing the claim and receiving reimbursement from the financial institution while the customer retains the exclusive right of recovery from the financial institution.

Yet another embodiment is directed to a check fraud protection method comprising receiving an order to print checks for a customer who has a checking account at a financial institution, and printing checks for the checking account per the order. According to embodiments, no check enrolled in the service includes any enrollment indicator or indicia, but checks may include an indicator for tracking check fraud as opposed to an indicator used to determine whether a check is covered by a check fraud protection service. The method further comprises receiving a claim from the customer requesting compensation for fraudulent activity involving a check printed per the order, determining a source of the fraudulent activity based at least in part upon the indicator.

An additional embodiment is directed to a check fraud protection method that comprises receiving an order to print checks for a customer who has a checking account at a financial institution and transmitting the order to a check printer who prints checks per the order. The printed checks are shipped form the printer to the customer. With embodiments, chain of custody data of the order and printed checks is stored to a database or table.

Further embodiments are directed to systems and computer program products that are configured for implementing check fraud protection method embodiments. In one system embodiment, a check fraud program may be programmed to store data including a start date of a check fraud protection service and a date a customer ordered checks and was automatically enrolled in the check fraud protection service into a table or database. When a check is involved in fraudulent activity, a check fraud program determines or receives the enrollment date of that check and/or a print date, and compares the enrollment date and/or print date and the start date to determine whether the check is covered. Thus, with embodiments, no enrollment indicator printed on a check is utilized or required, and it is not necessary to track or refer to check numbers or check sequences for purposes of determining whether a check is covered under a check fraud protection service.

In another system embodiment, the database stores chain of custody information indicating who handled the order and printed checks at different stages of processing or the department or location of such persons. For example, data of the person who received the order, the person or operator or printed the checks, the person who shipped the checks, and the person who delivered the checks can be tracked according to embodiments, e.g., by scanning or entering check data and/or data related to each person involved in the check printing process and transmitting and storing that data to a database. According to another embodiment, at least some of this data, if known prior to printing, can be encoded into a custody indicator, which is printed on each check of an order and subsequently read or decoded in order to determine chain of custody data. The custody indicator, however, is not utilized to determine whether the check is covered by the check fraud protection service and is not a check number.

In a single or multiple embodiments, the customer always retains the right of recovery from the financial institution. As such, the customer's claim is processed and resolved without requiring the customer to sign a power of attorney. In this manner, in contrast to other known systems, neither the service provider nor a printer of the checks has any right at anytime during processing of the claim to any portion of any payment made by the financial institution.

According to certain embodiments, if the customer is not fully compensated by the financial institution, the difference between the amount paid by the financial institution and what is owed to the customer (limited by a maximum amount or cap of fraud protection) is paid by another party such as the provider of the check fraud protection service or an insurer or underwriter thereof. The financial institution may approve payment of only a portion of the financial loss or may deny the claim altogether due in part to negligence or fault of the customer, e.g., as determined by a customer statement or a police report.

In a single or multiple embodiments, the request for compensation can be made by the customer initially or by the service provider on behalf of the customer. Thus, according to certain embodiments, the service provider serves as an advisor or consultant to the customer while the customer seeks reimbursement from the financial institution.

Further, in a single or multiple embodiments, the customer may be compensated even if there is no financial loss and even if there is no actual fraud. For example, if the customer's account was compromised or customer information was stolen, but there has not yet been any check fraud or activity involving the compromised data, that account can be closed, another account opened, and new checks printed and provided to the customer free of charge, and these new checks can be automatically enrolled in the check fraud protection service. According to embodiments, no enrollment indicator or indicia printed on any new check is used to indicate that a check is covered by the check fraud protection service. Instead, with embodiments, new checks are enrolled if the order or print date is after the date the check fraud protection service was launched or began such that it is not necessary to print any enrollment indicator on any new check. In certain embodiments, the first set of checks includes a custody indicator for tracking chain of custody of checks of the first order, and the second set of checks includes a second custody indicator for tracking chain of custody of checks of the second order, but no custody indicator is printed on any check for use in determining whether the check is enrolled in the check fraud protection service.

In a single or multiple embodiments, a custody indicator printed on a check is used to determine chain of custody data to trace or investigate the origin of fraudulent activity involving the check. For this purpose, a chain of custody database can be accessed to obtain data related to a check or order including the checks based at least in part upon the chain of custody indicator printed on the check. According to one embodiment, a check fraud program may be configured to look up the name or the customer or the custody indicator within a table or database to locate related data about the check, account, order, and other customer data. The custody indicator may be selected by the service provider or be a randomly generated number. In another embodiment, the chain of custody indicator is encoded with such data, which may be decoded to determine the corresponding data. Thus, with embodiments, it is not necessary to print any indicator on a check for purposes of identifying the check as being enrolled in a check fraud protection service, but a printed indicator may be utilized to track chain of custody

In a single or multiple embodiments, a custody indicator may be in the form of a serial number (as opposed to a check number). Each check or each check in a group or box is printed with its own unique serial number such that individual checks can be scanned, e.g., during printing and/or packaging, to determine check, account and customer data. The serial numbers are then used to track chain of custody of individual checks or a box of checks. The serial number may be in numeric form, such as a sequence of numbers. The serial number may also be encoded as a barcode, matrix or other code or symbol.

### BRIEF DESCRIPTION OF THE DRAWINGS

The foregoing and other aspects of embodiments are described in further detail with reference to the accompanying drawings, wherein:

FIG. 1 is a flow diagram of a method for automatically enrolling printed checks into a check fraud protection service according to one embodiment;

FIG. 2 is a block diagram illustrating communications involved in printing checks and enrolling checks into a check fraud protection service according to one embodiment;

FIG. 3 generally illustrates a check and types of information printed on a check that may be enrolled in a check fraud protection service according to embodiments;

FIG. 4 is a flow diagram illustrating actions taken following discovery of fraudulent activity according to embodiments;

FIG. 5 is a block diagram illustrating communications involved in actions following discovery of fraudulent activity according to embodiments;

FIGS. 6A-B illustrate types of data that may be used to determine whether a check is covered under a check fraud protection system according to certain embodiments;

FIG. 7 is a flow diagram of one embodiment of a method for administratively placing a customer in a pre-fraud position following fraudulent activity that did not result in financial loss to the customer;

FIG. 8 is a block diagram illustrating communications involved in one embodiment for administratively placing a customer in a pre-fraud position following fraudulent activity that did not result in financial loss to the customer;

FIG. 9 is a flow diagram of one embodiment of a method for processing a claims for reimbursement for fraudulent activity causing financial loss to the consumer based at least in part upon whether the consumer was negligent or at least partially at fault;

FIG. 10 is a block diagram illustrating communications involved in one embodiment for processing a claim for reimbursement for fraudulent activity causing financial loss to the consumer based at least in part upon whether the consumer was negligent or at least partially at fault;

FIG. 11 is a flow diagram of one embodiment of a method for processing a claims for reimbursement for fraudulent activity causing financial loss to the consumer in which a financial institution reimburses the customer for the entire amount of financial loss;

FIG. 12 is a block diagram illustrating communications involved in one embodiment for processing a claims for reimbursement for fraudulent activity causing financial loss to the consumer in which a financial institution reimburses the customer for the entire amount of financial loss;

FIG. 13 is a flow diagram of one embodiment of a method for processing a claims for reimbursement for fraudulent activity causing financial loss to the consumer in which a financial institution partially reimburses the customer for the entire amount of financial loss;

FIG. 14 is a block diagram illustrating communications involved in one embodiment for processing a claims for reimbursement for fraudulent activity causing financial loss to the consumer in which a financial institution partially reimburses the customer for the entire amount of financial loss;

FIG. 15 is a flow diagram of one embodiment of a method for processing a claims for reimbursement for fraudulent activity causing financial loss to the consumer in which a financial institution denies the claim and the customer is reimbursed by a service provider or insurer;

FIG. 16 is a block diagram illustrating communications involved in one embodiment for processing a claims for reimbursement for fraudulent activity causing financial loss to the consumer in which a financial institution denies the claim and the customer is reimbursed by a service provider or insurer;

FIG. 17 is a flow diagram of one embodiment of a method for storing chain of custody data utilizing a chain of custody indicator that is not used to determine whether a check is covered by a check fraud protection service

FIG. 18A illustrates an embodiment in which a chain of custody indicator is printed on a check and one way in which a custody indicator may be processed or decoded to retrieve chain of custody data, and FIG. 18B illustrates an embodiment in which a chain of custody indicator is a serial number;

FIG. 19 is a flow diagram of one embodiment of a method for generating and storing chain of custody data for an order of checks;

FIGS. 20A-B are tables illustrating different types of information including chain of custody data that can be stored, searched and accessed using a chain of custody indicator that is not used to determine whether a check is covered by a check fraud protection service; and

FIG. 21 is a block diagram of a computing apparatus or system in which various embodiments may be implemented or that may be utilized to execute various embodiments.

### DETAILED DESCRIPTION OF ILLUSTRATED EMBODIMENTS

Embodiments are generally related to check fraud protection methods and systems. Certain embodiments involve how individual and business account holders (generally, “customers”) are enrolled in check fraud protection services, how a check fraud protection service provider determines whether a check is covered under a check fraud protection service, how a customer is reimbursed or compensated for fraud, and how check fraud can be traced and investigated.

With embodiments, enrollment in a check fraud protection service is automatic as a default that can be changed if necessary, and may be mandatory. According to one embodiment, a check is determined to be enrolled in the check fraud protection service if the order or print date of the check or box of checks is after the start date of the check fraud protection service. Thus, with embodiments, no enrollment indicator or indicia printed on the check is used to determine whether the check is covered or enrolled in the check fraud protection service. As such, embodiments that utilize service enrollment based on service start and check order data simplify check printing. Further, in embodiments, customers retain the exclusive right of recovery from financial institutions without having to assign or sell their right of recovery to a third party or provider of the check fraud protection service.

Embodiments also provide for reimbursing customers in the event that a financial institution denies a reimbursement claim or only pays a portion of the financial loss such that the customer is made whole or more whole. For this purpose, supplemental or secondary reimbursement may be paid to the customer by the provider of the check fraud protection service and/or an insurer or underwriter of the service provider. Further, with embodiments, in the event of fraudulent activity regardless of whether there is financial loss, customers are provided with new checks for a new account at no charge.

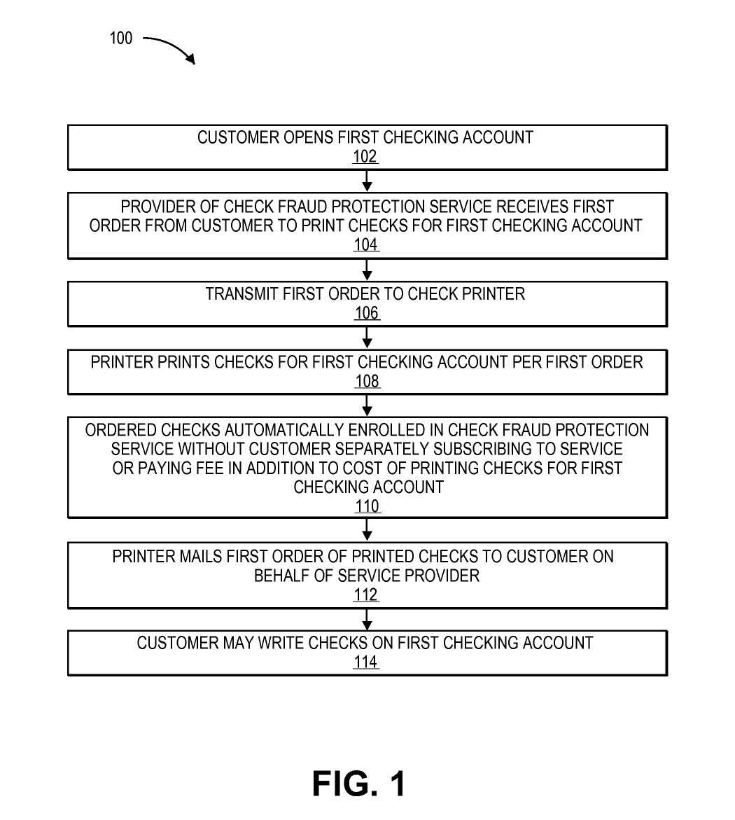

According to embodiment, a custody indicator such as a serial number printed or embedded within the check, is used to access custody data to trace the chain of custody of individual checks or an order or box of checks involved in fraudulent activity if the fraud involves an internal source such as the provider of the check fraud protection service or a check printer. Such custody indicators, however, are not used and not necessary to determine whether the check is enrolled in the check fraud protection service since embodiments involve enrollment determinations that are instead based on comparing check order or print dates and a date the check fraud protection service was launched or began. For this purpose, each check may include its own or unique serial number, which may be scanned at different stages of printing and processing, and the scanned data is stored to a chain of custody database. Further, a container or box of multiple checks can be encoded with a chain of custody indicator, code or other appropriate symbol representing certain serial numbers of respective checks within the box. For this purpose, different numbers can be serially or sequentially printed on respective checks. Embodiments and aspects thereof are described in further detail with reference to FIGS. 1-21.

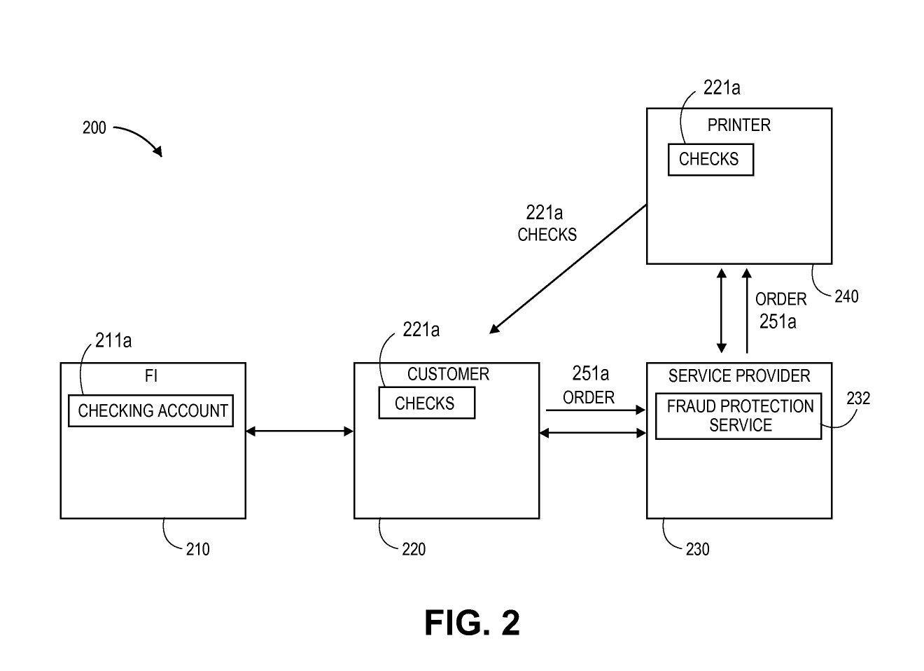

Referring to FIGS. 1-2, a check fraud protection method 100 according to one embodiment involves or can be implemented using a system 200 involving or comprising a financial institution 210 such as a bank, credit union or other financial institution (generally, “FI”) at which a user, client, customer, account holder or customer 220 (generally, “customer”) has a first checking account 211a (“first checking account 221a” or generally, “checking account 211”). Customer 220 uses a first set of checks 221a (“first checks 221a” or generally, “checks 221”) that may be tendered for payment of goods and services with funds withdrawn from the checking account 221. “Customer” 220 is defined herein as including both individual and business customers. While FIG. 2 generally illustrates FI 210 and customer 220, it will be understood that communications between FI 210 and customer 220 may be via a network using a computer, by mail, facsimile or other form of electronic communication, or by customer 220 visiting FI 210 in person.

With continuing reference to FIG. 1, method 100 comprises, at 102, customer 220 opening first checking account 211a at FI 210 and, at 104, ordering 251a a first set of checks 211a, such as pre-printed checks, from a source or vendor 230. According to one embodiment, first order 251a (“first order 251a” or generally, “order 251”) is received at a source or vendor 230 that is also a provider of a check fraud protection service 232. For ease of explanation, reference is made to service provider 230 and fraud protection service 232.

According to one embodiment, fraud protection service 232 protects customers 220 against fraudulent activity involving checking account 211. As discussed in further detail below, fraud protection service 232 allows customer 220 to be reimbursed in the event that FI 210 does not reimburse or only partially reimburses customer 220 for financial loss resulting from fraudulent activity involving a check 221 that was part of order 251.

According to one embodiment, such protection is available for a pre-determined term or time from the date checks are ordered (e.g., a certain number of months or years such as one year, two years or other terms from the order date) and/or up to a maximum coverage amount or cap of financial loss (e.g., reimbursement not to exceed $50,000, $100,000 and other amounts). Protection can be renewed for additional terms each subsequent check order such that each new order is covered for the pre-determined term up to the maximum coverage amount.

With continuing reference to FIG. 1, at 104, service provider 230 receives first order 251 from customer 220 to print checks 221 for first checking account 211. If service provider 230 utilizes a third party or other vendor for this purpose, at 106, service provider 230 transmits order 251 and any other relevant information to a printer 240, examples of which include Harland Clarke, Deluxe Corporation and other check printers 240. At 108, printer 240 prints checks 221 for first checking account 211 per order 251 received from service provider 230 which, at 110, automatically enrolls printed checks 221 in fraud protection service 232. According to embodiments, printed checks 221 are automatically enrolled in check fraud protection service 232 without customer 220 separately subscribing to service 232 or paying fee in addition to cost of printing checks 221. Thus, according to embodiments, enrollment in fraud protection service 232 is automatic as a default and may be mandatory.

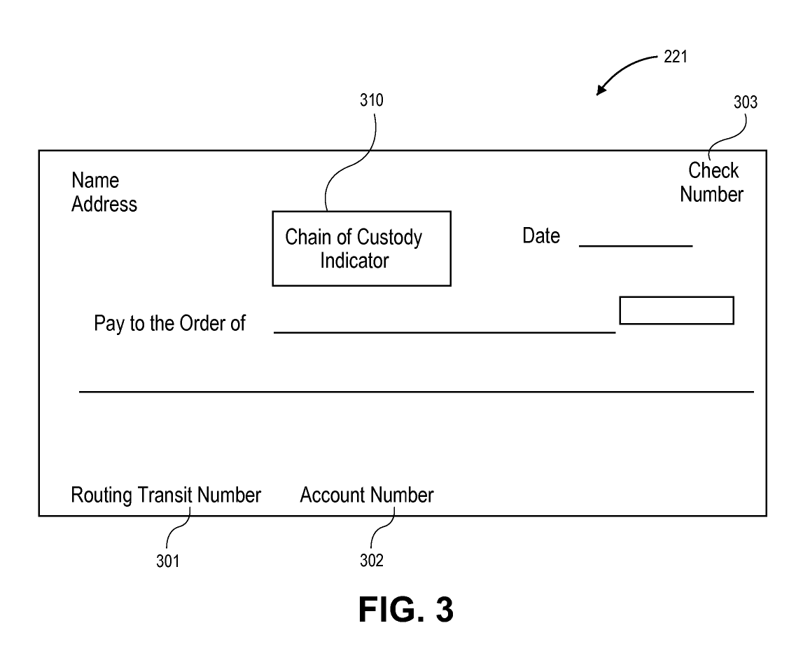

Referring to FIG. 3, a check 221 printed by printer 240 and that may be enrolled in the check fraud protection service 232 may include information such as Magnetic Ink Character Recognition (MICR) line data, which is used by FIs 210 to allow computers to read check data and may include the Routing and Transit Number (RTN) 301, account number 302, check number 303 and other information identifying check 221 and account holder or customer 220. According to certain embodiments, it is not necessary to print an enrollment indicator on the check, and embodiments may involve a custody indicator 310 configured for use in tracking check history and the source of fraudulent activity involving the check 221.

While FIG. 3 illustrates a custody indicator 310 generally, it will be understood that various custody indicators 310 may be utilized, and that such custody indicators 310 are not used to determine whether a check is enrolled in check fraud protection service 232 since check 221 is automatically enrolled in service 232 if the order or print date of check 221 is on or after the date check fraud protection service 232 began or was launched. Thus, in certain embodiments, no indicator is printed on any check 221, whereas in other embodiments, custody indicator 310 is printed on checks 221.

According to one embodiment, checks 221 are pre-printed checks that, for example, may be used with various personal and business related financial management systems and programs including, for example, QUICKBOOKS, QUICKEN, Microsoft Money and PEACHTREE, and other accounting, finance programs or financial management software or systems that are capable of printing check related information. QUICKBOOKS and QUICKEN are registered trademarks of Intuit Inc., Mountain View, Calif.; PEACHTREE is a registered trademark of Sage Software, Inc. Such pre-printed checks 221 include information such as a checking account number, and name of a person or business such that it is not necessary to write this information on the check. Such checks may be Magnetic Ink Character Recognition (MICR) enabled such that printed checks may include data to allow FI computers to read check data such as RTN 301 and account number 302. For ease of explanation, reference is made generally to checking account 211 and check 221, which may be, a pre-printed or other type of check or negotiable instrument.

Referring again to FIGS. 1-2, at 112, after checks 221 have been printed, they are mailed from printer 240 to customer 220 on behalf of service provider 230. At 114, customer 220 can now write checks 221 against checking account 211 to purchase goods and services.

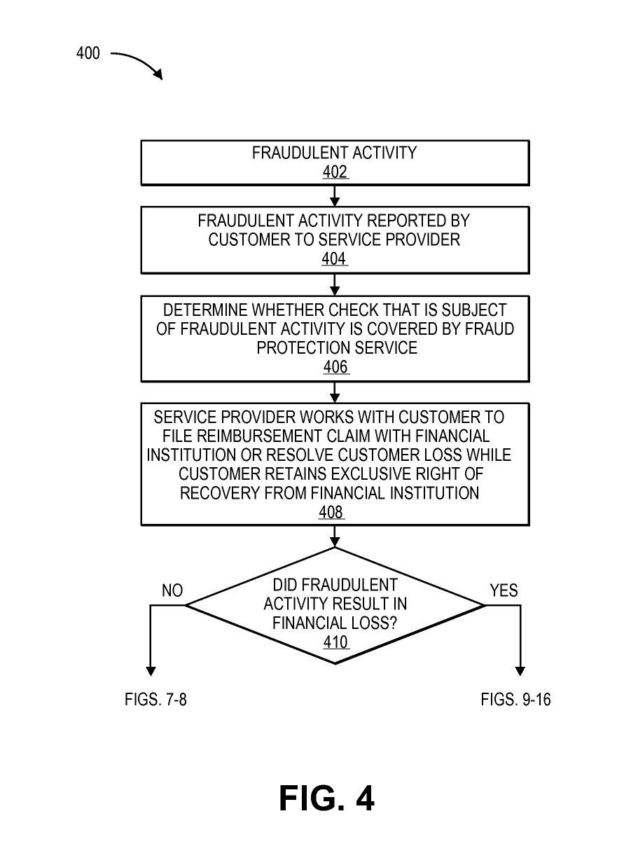

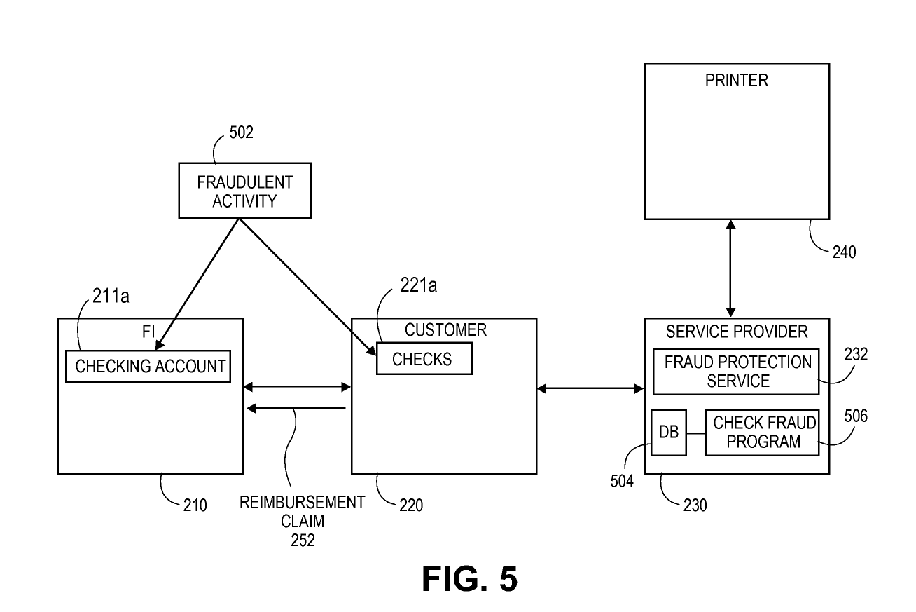

Referring to FIGS. 4-5, in a method 400 according to one embodiment, at 402, customer 220 is eventually a victim of fraudulent activity 502 involving first checking account 211 and/or check 221 of customer 220. Fraudulent activity 502 is discovered by customer 220, or customer 220 is notified of fraudulent activity 502 by FI 210. Customer 220 reports fraudulent activity 502 or submits a claim to service provider 230 at 404 per fraud protection service 232 requirements. At 406, service provider 230 determines whether check 221 involved in fraudulent activity 502 is covered by fraud protection service 232. According to embodiments, determining whether subject check 221 is covered by or enrolled in check fraud protection service 232 does not involve any indicator printed on the check and instead, is based upon whether the order or print date of subject check 221 is after check fraud protection service 232 began such that it is not necessary to print any indicator on any enrolled check.

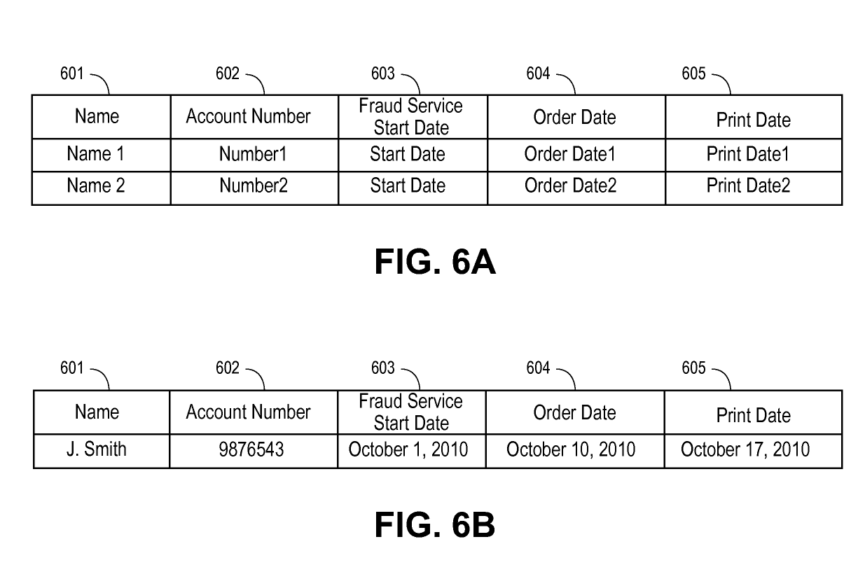

For example, referring to FIGS. 6A-B, determining whether fraud protection service 232 applies is based at least in part upon locating data related to check 221 in a table or database 504 (“DB” in FIG. 5). In the illustrated embodiments, table or database 504 may include columns 601-605 for a name of customer 220 or other customer 220 identifier, checking account 211 number, start date of fraud protection service 232, date of order 251 including subject check 221 and print date if applicable. Thus, by searching for service provider 230 records in a database 504, for example, data of customer 220 and checking account 221 may be identified, and corresponding data including the start date of fraud protection service 232 and order 251 and/or print dates can be determined and compared manually by an agent of service provider 230 or by a check fraud program 506 (as shown in FIG. 5) executing on a computer of service provider 230. Thus, if the order date and/or print dates are after the start date of the check fraud protection service 232, then program 506 is configured to determine that fraud protection service 232 applies to cover check 221 unless the time between the start date and the order date exceeds the duration of time from the fraud protection service 232 start date.

FIG. 6B illustrates one example in which a customer 220 name or other customer 220 identifying data is keyed to a start date of Oct. 1, 2010 and an order 251 date of Oct. 10, 2010. In this example, subject check 221 would be covered by fraud protection service 232 unless the term has expired.

Referring again to FIGS. 4-5, after being notified by customer 220 at 402, and if subject check 221 is covered by fraud protection service 232 at 404, service provider 230 works with customer 220 to prepare and file a reimbursement claim with FI 210 as appropriate or otherwise resolve the loss suffered by customer 220 at 406. During this process, customer 220 retains exclusive right of recovery from FI 210. In this manner, customer 220 is not required and does not assign any right of recovery to service provider 230, printer 240 or any other third party. Instead, customer 220 retains these rights, and service provider 230 acts as an advisor or consultant to assist customer 220 in preparing the necessary documentation for a reimbursement request 252, which is sent to FI 210 from customer 220.

Thus, embodiments operate in a manner that is in contrast to other methods that require customer 220 to assign rights to another party, e.g., by executing a power of attorney form. In this manner, customer 220 ultimately retains control of the reimbursement process, retains the exclusive right of recovery to payment made by FI 210, and is not required to review a power of attorney form prepared by another party or retain and pay an attorney to review such legal documents.

According to one embodiment, customer 220 is compensated for financial loss, and service provider 230 undertakes administrative actions to address fraudulent activity, and any such costs associated with these administrative actions are not charged to customer 220. In these embodiments, determinations regarding whether and how much customer 220 should be compensated, and from which source, and which types of administrative actions are required, begins with stage 410 of service provider 230 determining whether fraudulent activity 502 resulted in financial loss to customer 220.

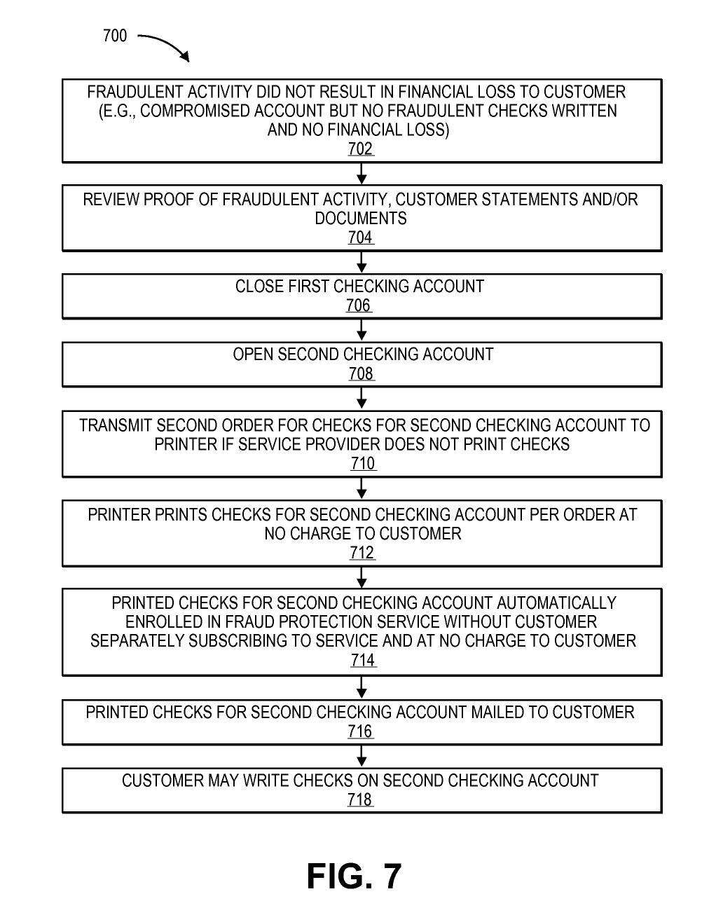

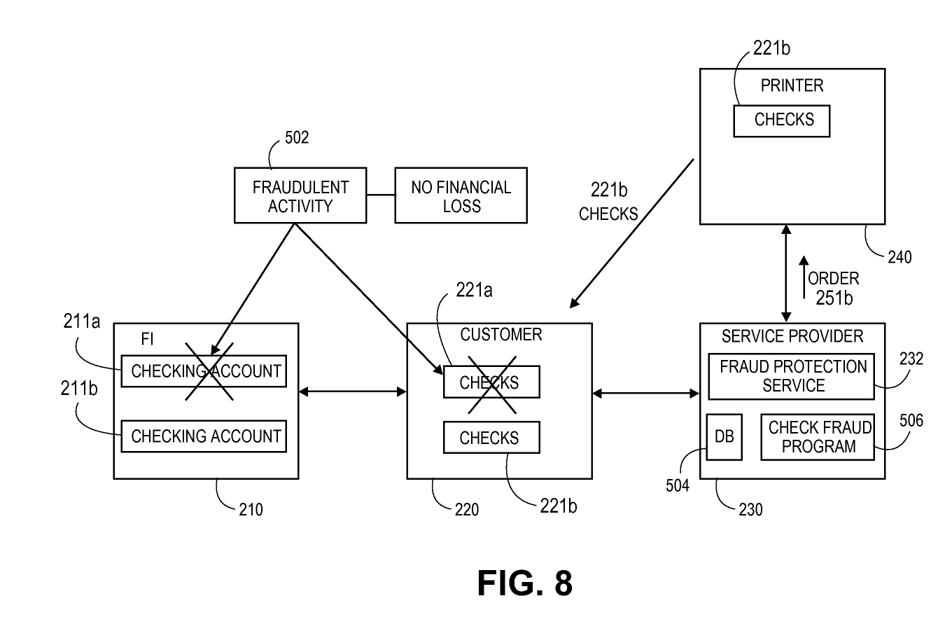

Referring to FIG. 7, and with further reference to FIG. 8, in a method 700 according to another embodiment, at 702, if customer 220 did not suffer any financial loss (e.g., checking account 211 was compromised, but there has not been fraud resulting in financial loss), then at 704, service provider 230 reviews proof, statements or documents related to fraudulent activity 502 so that service provider 230 and/or FI 210 can attempt to enact procedures to prevent such activities in the future. For purposes of processing cases that do not involve financial loss to customer 220, verbal and/or written statements are sufficient, and a police report is not required, although a police report may also be utilized. Service provider 230 works with customer 220 to have customer 220 close first checking account 211 at 706 (indicated by “X” through first checking account 211a in FIG. 8), open a new, second checking account 211b at 708, and at 710, transmit a second order 251b for new checks 221b for second checking account 211b to printer 240 (“X” through first checks 221a indicating checks 221a are no longer valid). At 712, printer 240 prints new checks 221b for second checking account 211b per second order 251b at no charge to customer 220.

At 714, printed checks 221b for second checking account 211b are automatically enrolled in check fraud protection service 232 without customer 220 separately subscribing to service 232 and at no charge to customer 220. Further, with embodiments, no enrollment indicator or other enrollment indicia for indicating is printed on any check of second checking account 211b. Instead, according to embodiments, determinations whether checks 221b for second checking account 211b are covered by or enrolled within check fraud protection service 232 are made based upon whether the order of checks for second checking account 211b or the print date of new checks 221b is after the date check fraud protection service 232 was launched or began.

Referring again to FIG. 7, at 716, printed checks 221b for second checking account 211b are mailed to customer 220, who may then write checks 221b on second checking account 211b at 718 to purchase goods and services. Thus, even when there is no financial or out-of-pocket loss, with embodiments, customer 220 is placed in a pre-fraud position by administrative action coordinated by service provider 230, at no charge to customer 220.

One example of how embodiments may be implemented is illustrated by customer 220 receiving a call from FI 210 notifying customer 220 that checking account 221a has been compromised due to a security breach at FI 210. Customer 220 contacts service provider 230 requesting new checks 221b, and service provider 230 works with customer 220 to have customer 220 instruct FI 210 to close first checking account 211a and open second checking account 211b. Service provider 230 looks up customer 220 information (e.g., in database or table 540 shown in FIGS. 5-6F) and reminds customer 220 that checks 221 of first checking account 211 are covered by fraud protection service 232 by determining that the order including the subject check 221 was made after the check fraud protection service 232 began. An agent of service provider 230 takes a verbal statement or account of the fraud exposure and asks customer 220 to send by mail or fax a written description of fraud exposure. Service provider 230 agent places a replacement order 251b for new checks 221b for second checking account 211b and any other suitable financial supplies. New printed checks 221b may be shipped to customer 220 as quickly as overnight such that customer 220 can use new checks 221b the next day without interruption in personal and business affairs, thereby resolving fraudulent activity 502 administratively and placing customer 220 in a pre-fraud position even though customer 220 did not suffer any financial loss.

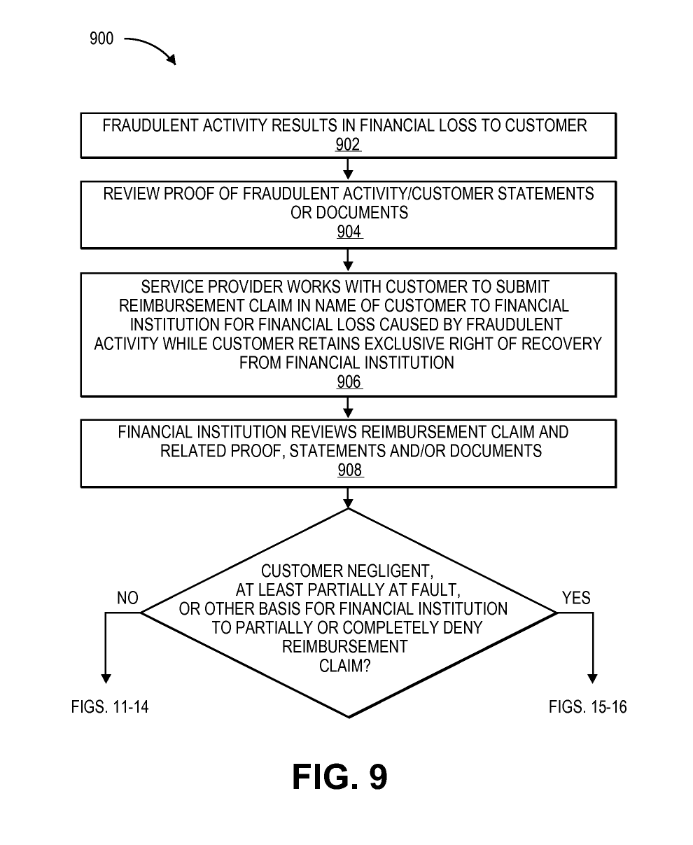

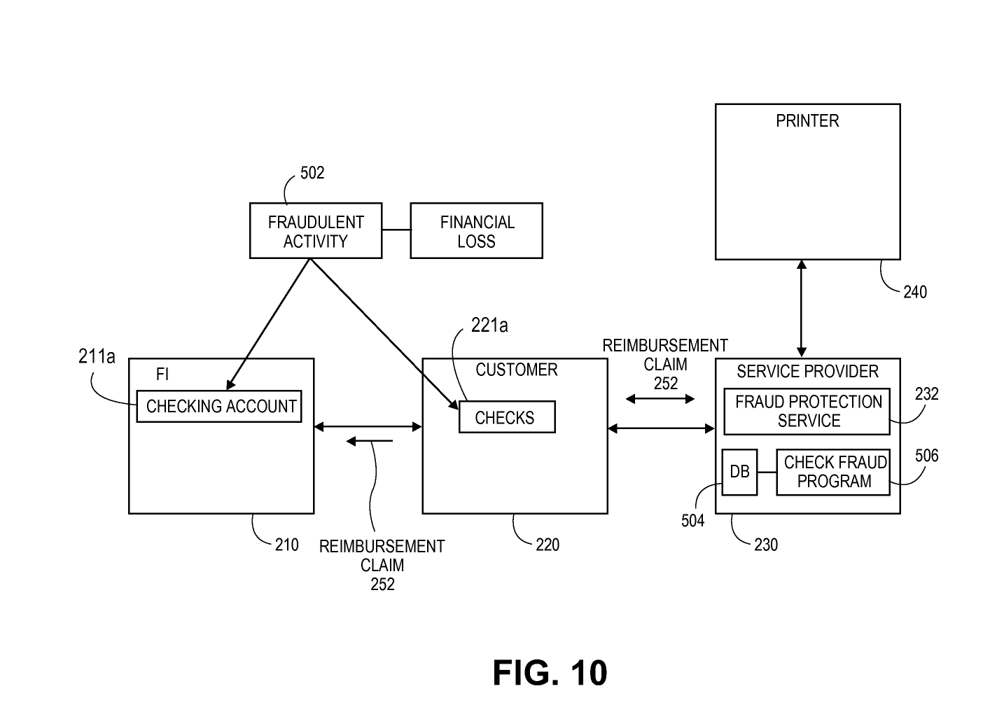

Referring again to FIG. 4, 410, and with further reference to FIGS. 9-10, in a method 900 according to another embodiment, at 902, customer 220 does suffer financial loss as a result of fraudulent activity 502, e.g., due to a stolen check, a forged signature or endorsement, a counterfeit check, an altered check etc. At 904, customer 220 provides and service provider 230 reviews verbal statements, documents and other proof of fraudulent activity 502. In cases involving financial loss, a police report may be required, whereas in cases that do not involve financial loss, a police report is optional.

At 906, service provider 230 works with customer 220 to prepare and file reimbursement claim 252 with FI 210 to be reimbursed for the financial loss. As explained above with reference to FIGS. 4-5, during this process, customer 220 retains exclusive right of recovery from FI 210 such that customer 220 is not required and does not assign any right of recovery to service provider 230, printer 240 or other third party. Instead, customer 220 retains these rights, and service provider 230 acts as an advisor or consultant to assist customer 220 in preparing the necessary documentation for reimbursement request 252. In this manner, customer 220 ultimately retains control of the reimbursement rights and process, retains the exclusive right of recovery to payment made by FI 210, and is not required to read and understand a legal document prepared by another party or retain and pay for an attorney to review the legal document, while customer 220 and service provider 230 work together to submit reimbursement claim 252 to the FI 210 in customer's name.

At 908, reimbursement claim 252 naming customer 220 together with any supporting statements, documents and other proof are reviewed by FI 210 which, at 910, determines whether fraudulent activity 502 that is the subject of reimbursement claim 252 was the result of or involved negligence or fault of customer 220 such that FI 210 may have grounds to deny claim 252 or whether there are other bases upon which claim 252 can be denied.

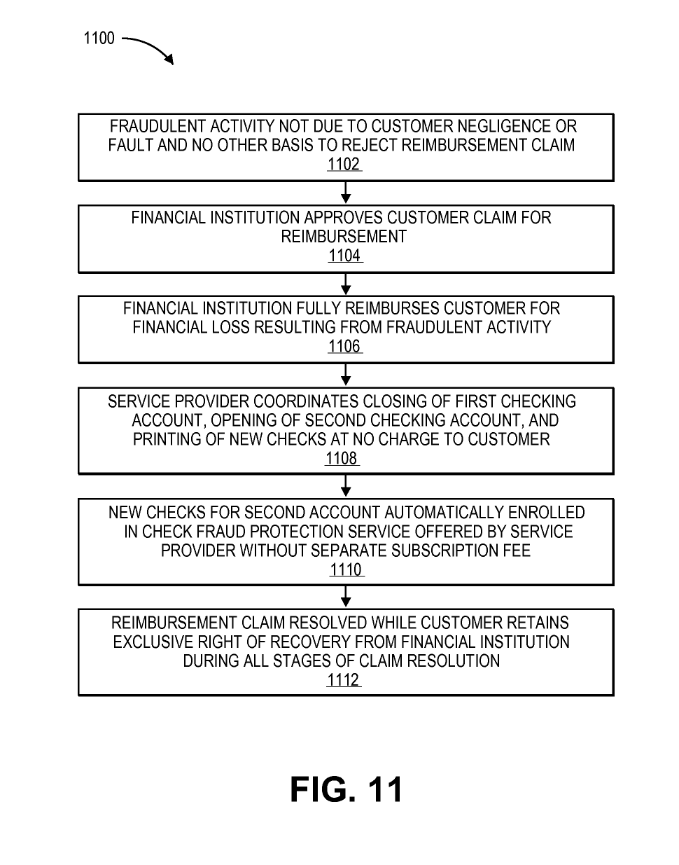

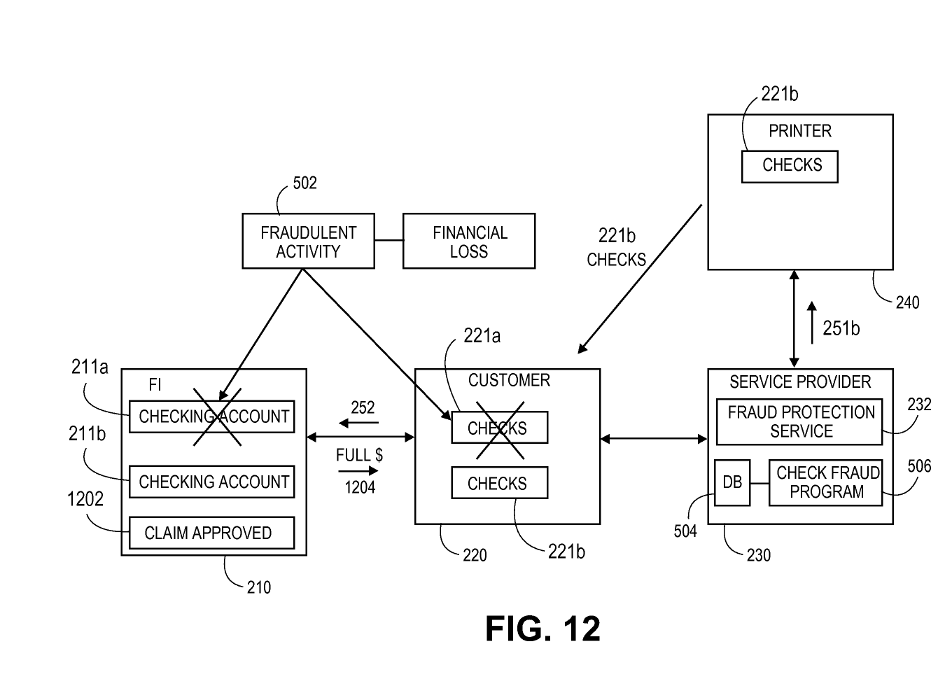

Referring to FIGS. 11-12, in a method 1100 according to one embodiment, at 1102, customer 220 was not negligent or at fault and there is no basis to reject reimbursement claim 252 such that, at 1104, FI 210 approves 1202 reimbursement claim 252. In the illustrated embodiment, at 1106, FI 210 fully reimburses (indicated as “Full $ 1204” in FIG. 12) customer 220 for the financial loss resulting from fraudulent activity 502. Further, at 1108, service provider 230 undertakes administrative action to place customer 220 in a pre-fraud position by working with customer 220 to have customer close first checking account 211a, open second checking account 211b and print new checks 221b for second checking account 211b to be sent to customer 220 free of charge and, at 1110, automatically enroll new checks 221b for second checking account 211b in fraud protection service 232 without a separate subscription or fee payable by customer 220. Thus, at 1112, reimbursement claim 252 is resolved by customer 220 receiving full reimbursement 1204 from FI 210 and also receiving new checks 221b at no charge, without having to execute a power of attorney to a third party and retaining the exclusive right of recovery from FI 210 during all stages of claim resolution.

One example of how embodiments may be implemented involves customer 220 falling victim to fraud due to checks 221a being stolen from customer 220, or a criminal acquired the account number and counterfeited a check or forged a signature for $5,000. Customer 220 remembers that checks 221a were covered by fraud protection service 232 and contacts service provider 230 to notify service provider 230 of the fraud. An agent of service provider 230 validates that checks 221a were purchased from service provider 230, that the check fraud protection service 232 applies by comparing whether the subject check 221 was ordered or printed after the check fraud protection service 232 began, and that the check 221a is still within the coverage period (e.g., a certain number of months or years from the order date) such that fraud protection service 232 still applies. A trained fraud resolution agent of service provider 230 may then be assigned to the customer's case and starts working on steps to resolve the fraud by working customer 220 to have customer 220 close first checking account 211a involved in fraudulent activity 502 and open new second checking account 211b. Agent verifies whether customer 220 requires financial reimbursement, and customer 220 confirms that the criminal has been writing checks 211a from first checking account 211a such that customer 220 has suffered financial loss to be reimbursed.

In cases involving financial loss, service provider 230 may require a copy of a police report and works with customer 220 on pursuing a claim 252 for recovery of funds for the fraud from FI 210 and to help restore customer 220 to a pre-fraud state administratively. In this example, FI 210 agrees to fully reimburse 1204 customer 220 and pays customer 220 the amount stolen from account 211a ($5,000 in this example). A new, second checking account 211b is opened at the FI 210, and service provider 230 submits replacement order 251b for new checks 221b and financial supplies free of charge to customer 220. With embodiments, there is no enrollment indicator or indicial printed on new checks 211b since enrollment in the check fraud protection service 232 is automatic and enrollment determinations are based on whether the order or print date of the new checks is after the date check fraud protection service 232 was launched or began.

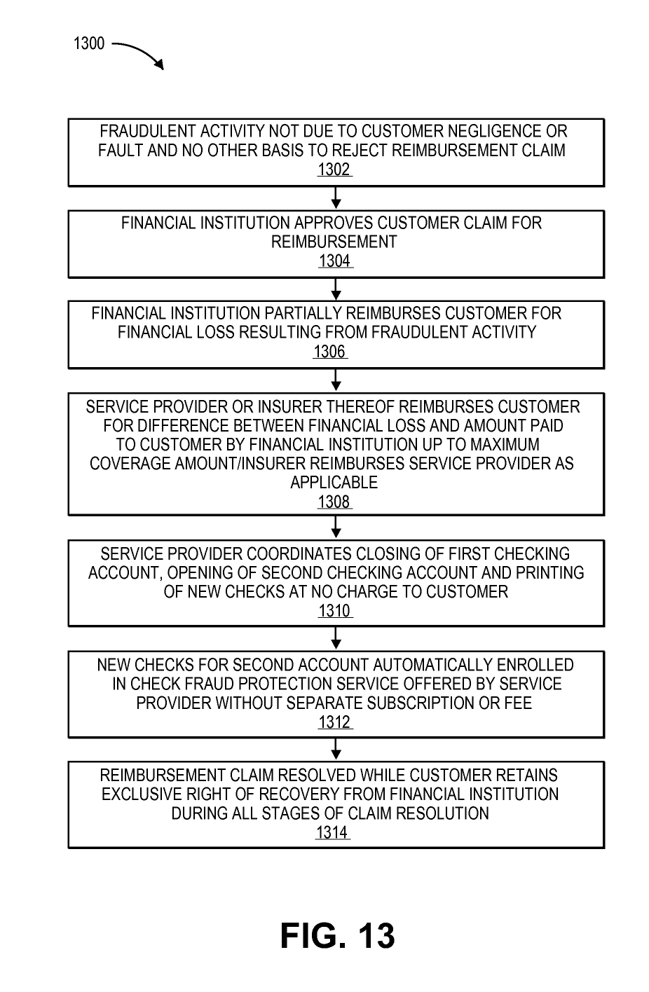

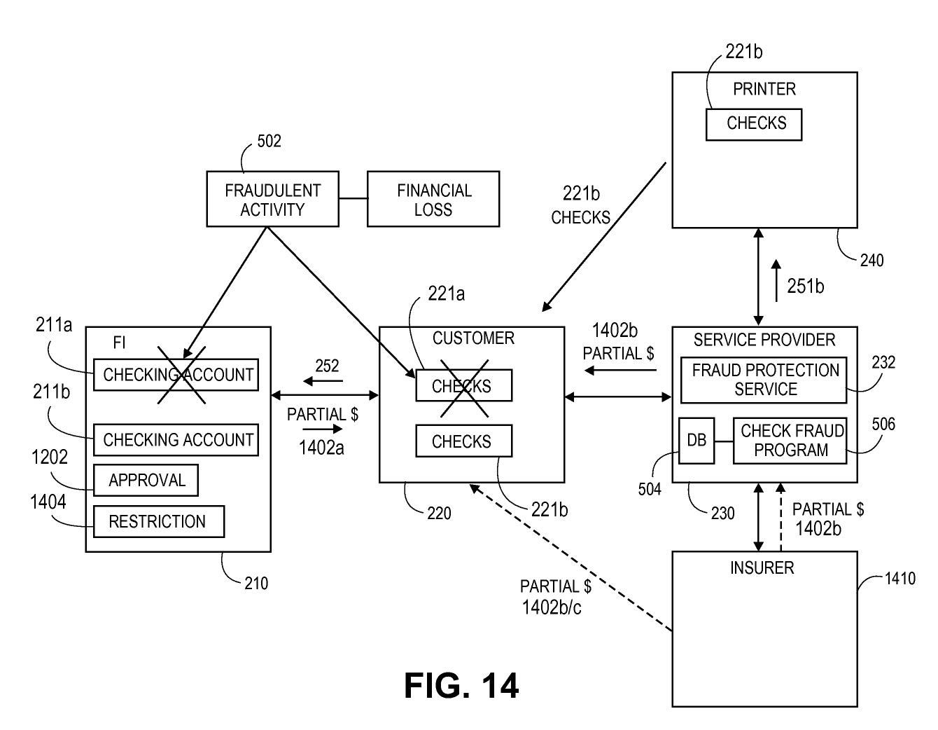

Referring to FIGS. 13-14, in a method 1300 according to another embodiment in which, at 1302, customer 220 was not negligent, not at fault, and there is no other basis to reject claim 252 for reimbursement, FI 210 approves 1202 the claim 252 at 1304 similar to the claim approval 1202 described above with reference to FIGS. 11-12. However, in the embodiment illustrated in FIGS. 13-14, FI 210, while approving 1202 claim 252, only pays a portion of the financial loss (illustrated as “Partial $ 1402”), e.g., due to an internal FI 210 restriction or limitation 1404 such as a maximum amount that can be paid by FI 210 to customer 220 for fraud. Thus, in this case, despite being covered by fraud protection program 232, and FI 210 approving 1202 claim 252, customer 220 is only partially reimbursed 1502 by FI 210 at 1306.

According to embodiments, at 1308, service provider 230, or an insurer or underwriter 1410 (generally, insurer 1410) thereof, reimburses customer 220 directly (illustrated as Partial$ 1402b”) for the remaining portion of the financial loss, i.e., the difference between financial loss and the partial amount paid to customer 220 by FI 210. While FIG. 14 shows partial payment 1402b made to customer 220 by service provider 230 (solid line) and insurer 1410 (solid line), it should be understood that either service provider 230 or insurer 1410 may directly pay partial payment 1402b to customer 220. Further, while FIG. 14 shows only one partial payment, embodiments may also involve a partial payment 1402b from service provider 230 and a partial payment 1402c from insurer 1410. In embodiments in which insurer 1410 does not pay customer 220 directly, service provider 230 is reimbursed (shown as dotted line in FIG. 14) by insurer 1410 for payments made by service provider 230 to customer 220.

As explained above, amount 1402b that can be paid by service provider 230 or insurer 1410 may be limited to the maximum coverage amount of fraud protection service 232. Thus, as long as the difference is less than the maximum coverage amount, customer 220 is fully reimbursed for financial loss from at least two, possibly three, different sources: FI 210, service provider 230 and insurer 1410 of service provider 230.

Further, at 1310, service provider 230 undertakes administrative action to place customer 220 in a pre-fraud position by working with customer 220 to have customer 220 close first checking account 211a, open second checking account 211b, and submit new order 251 for new checks 221b for second checking account 211b to be sent to customer 220 free of charge. At 1312, new checks 221b are automatically enrolled into fraud protection service 232 without a separate subscription or fee payable by customer 220. With embodiments, there is no enrollment indicator or indicial printed on any new check 211b since enrollment is automatic and enrollment determinations are based on comparing order or print dates and the date check fraud protection service 232 was launched or began.

Thus, at 1314, reimbursement claim 252 is resolved by customer 220 receiving a first partial reimbursement 1402a from FI 210, a second partial reimbursement 1402b from service provider 230 (or insurer 1410), and possibly a third partial reimbursement 1402c from the other of service provider 230 and insurer 1410 and receiving new checks 221b at no charge, all without having to execute a power of attorney to a third party and retaining the exclusive right of recovery from FI 210 during all stages of claim resolution.

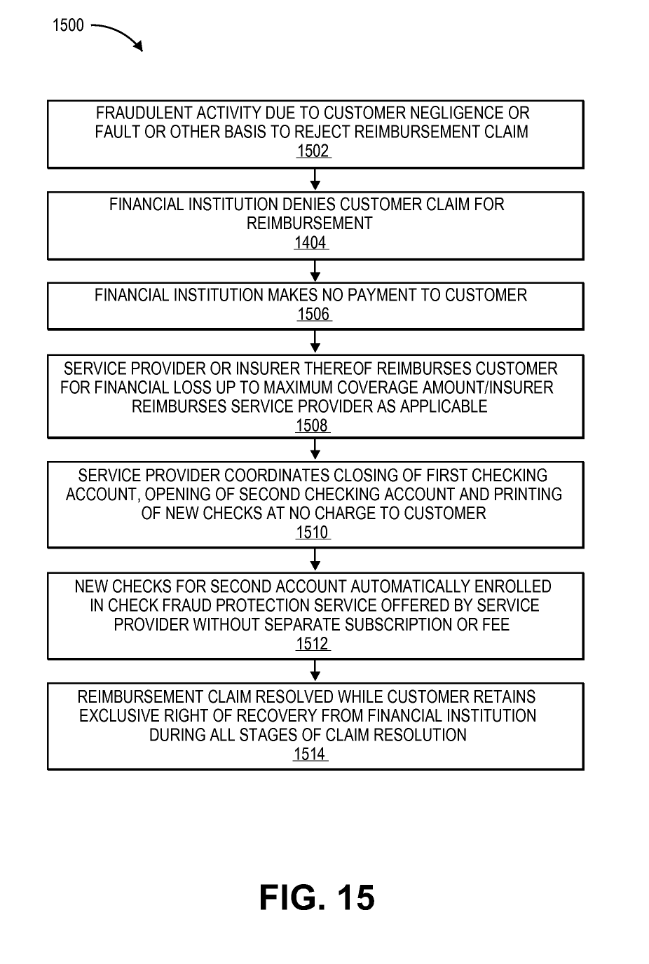

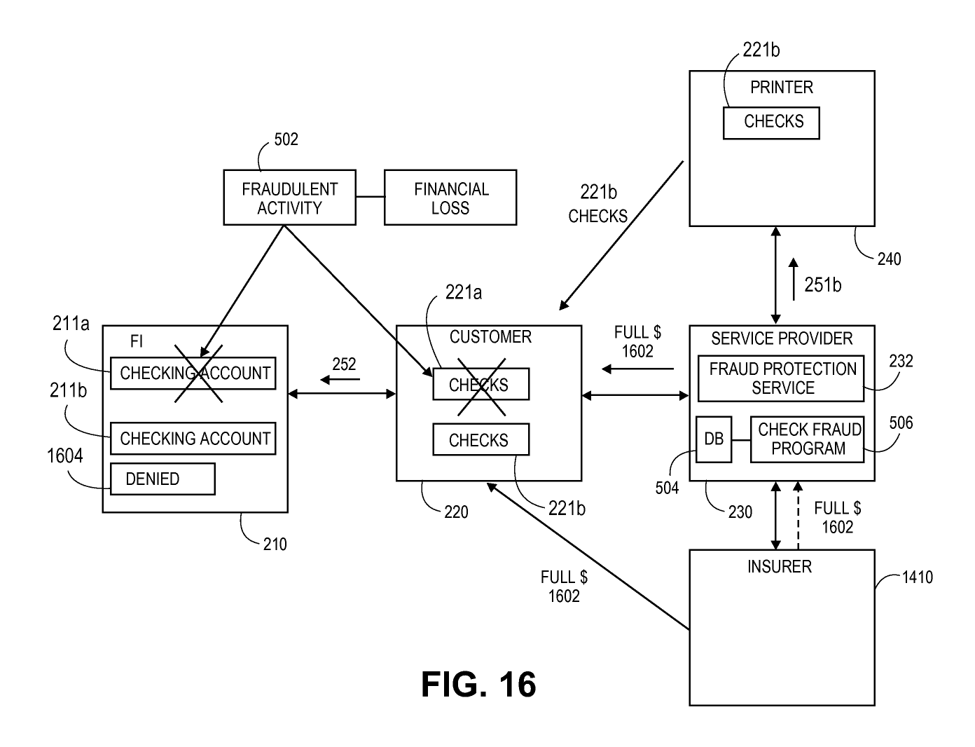

Referring to FIGS. 15-16, in a method 1500 according to another embodiment in which, at 1502, customer 220 was negligent or at least partially at fault thereby causing or enabling fraudulent activity 502, or there is another basis to reject claim 252 for reimbursement, FI 310 denies 1602 claim at 1504. As a result, FI 210 makes no payment to customer 220 at 1506. Consequently, under known systems and methods, this presents a scenario in which customer 220 is not reimbursed at all for financial loss caused by fraudulent activity 502.

However, with embodiments, at 1508, service provider 230, or insurer 1410 thereof, reimburses customer 220 directly (shown by solid line) for the financial loss not exceeding the maximum coverage amount of check fraud protection service 232. While FIG. 16 shows payment in full 1602 made to customer 220 by service provider 230 (solid line) or insurer 1410 (solid line), it should be understood that either service provider 230 or insurer 1410 may directly pay the full payment 1602 to customer 220.

In an alternative embodiment, full payment 1602 is allocated or divided among service provider 230 and insurer 1410 such that service provider 230 may pay a first portion of full payment 1602 to customer 220, and insurer 1410 may pay a second portion of full payment 1602 to customer 220. Further, in embodiments in which insurer 1410 does not pay customer 220 directly, service provider 230 is reimbursed (shown as dotted line in FIG. 16) by insurer 1410 for payments made by service provider 230 to customer 220.

Thus, with embodiments, if financial loss is less than the maximum coverage amount, customer 220 is nevertheless fully reimbursed 1602 for the entire financial loss from at least one source other than FI 210 (service provider 230 or insurer 1410) or multiple sources other than FI 210 (service provider 230 and insurer 1410), despite FI 210 denying 1604 the reimbursement claim and paying nothing to customer 220.

Additionally, service provider 230 works with customer 220 to close first checking account 211a, open second checking account 211b and submits new order 251b for new checks 221b for second checking account 211b to be sent to customer 210 free of charge at 1510. At 1512, new checks 221b are automatically enrolled in fraud protection service 232 without separate subscription or fee payable by customer 210. With embodiments, it is not necessary to print an enrollment indicator on the new checks since enrollment is automatic and enrollment determinations are based on whether the order or print date of the new checks is after the check fraud protection service was launched or began.

At 1514, reimbursement claim 252 is resolved by customer 220 receiving reimbursement from service provider 230 and/or insurer 1410 despite FI 210 paying nothing to customer 220, and also receiving new checks 221b at no charge, all without having to execute a power of attorney to a third party and retaining the exclusive right of recovery from FI 210 during all stages of claim resolution.

Thus, according to embodiments, fraud protection service 232 may be structured such that service provider 230 and/or insurer 1410 compensate customer 220 for any difference between an amount of financial loss suffered by customer 220 and the amount paid by FI 210 in cases in which FI 210 approves claim 252 (up to the maximum coverage amount and assuming check fraud protection service 232 applies), whereas if claim 252 is denied by FI 210, customer 220 is still reimbursed up to the maximum coverage amount by service provider 230 and/or insurer 1410, but not FI 210.

One example of how embodiments may be implemented involves customer 220 who forgot to lock an office door, thereby allowing a criminal to steal checks 221a from the customer's office. The criminal has written checks on first checking account 211a in the amount of $15,000. Customer 220 remembers that checks 221a are covered by fraud protection service 232 and contacts service provider 230. An agent of service provider 230 confirms that checks 221a were purchased from service provider 230, that the check fraud protection service 232 applies by comparing the order or print date of subject check and the date the check fraud protection service 232 was launched or began, and that with such dates, coverage still applies. A trained fraud resolution agent of service provider 230 is assigned to the customer's case and starts working on steps to resolve fraud, which includes working with customer 220 to have customer 220 close first checking account 211a, and open new, second checking account 211b. Service provider 230 agent verifies whether customer 220 would require financial reimbursement, and customer 220 confirms that there was financial loss caused by the criminal writing checks from first checking account 211a. In cases involving financial loss, service provider 230 agent requests that customer 220 provide a police report and works with customer 220 on pursuing claim 252 for recovery from FI 210 while customer 220 retains the exclusive right of recovery from FI 220 and to also place customer 220 in a pre-fraud state administratively. For this purpose, after new, second checking account 211b is opened at FI 210, service provider agent submits replacement order 251b for new checks 221b free of charge to customer 220. With embodiments, it is not necessary to print an enrollment indicator on the new checks since enrollment is automatic and enrollment determinations are based on whether order or print date of new checks 221b is after the check fraud protection service 232 was launched or began.

In this example, however, FI 210 denies the reimbursement claim 252 to restore funds to customer's first checking account 211a due to negligence or fault of customer 210 in failing to lock the office door, which allowed or facilitated the criminal to steal checks 221a. Normally, this situation would be devastating to customer 220 since customer 220 is not reimbursed. However, with embodiments, service provider 230 or insurer 1410 thereof reimburses customer 220 for financial loss not exceeding the maximum coverage amount. If payment is made by service provider 230, insurer 1410 may reimburse service provider 230. Thus, customer 220 is compensated for financial loss, has new checks 221b for second checking account 221a at no charge, and this case of fraud has been resolved both financially and administratively, even in cases involving negligence and fault of customer 220.

Embodiments described above with reference to FIGS. 1-16 have involved fraud protection service 232, and determining whether a check is covered by fraud protection service 232 by comparing check order or print dates and when the check fraud protection service was launched or began such that no enrollment indicator is printed on any check covered by check fraud protection service 232.

According to another embodiment, a chain of custody indicator 310 may be printed on checks for use in tracking the chain of custody of order 251 of checks such that persons involved in processing order 251 can be individually traced and identified, which may be particularly useful in the event that the source of the fraudulent activity is within service provider 230 or printer 240.

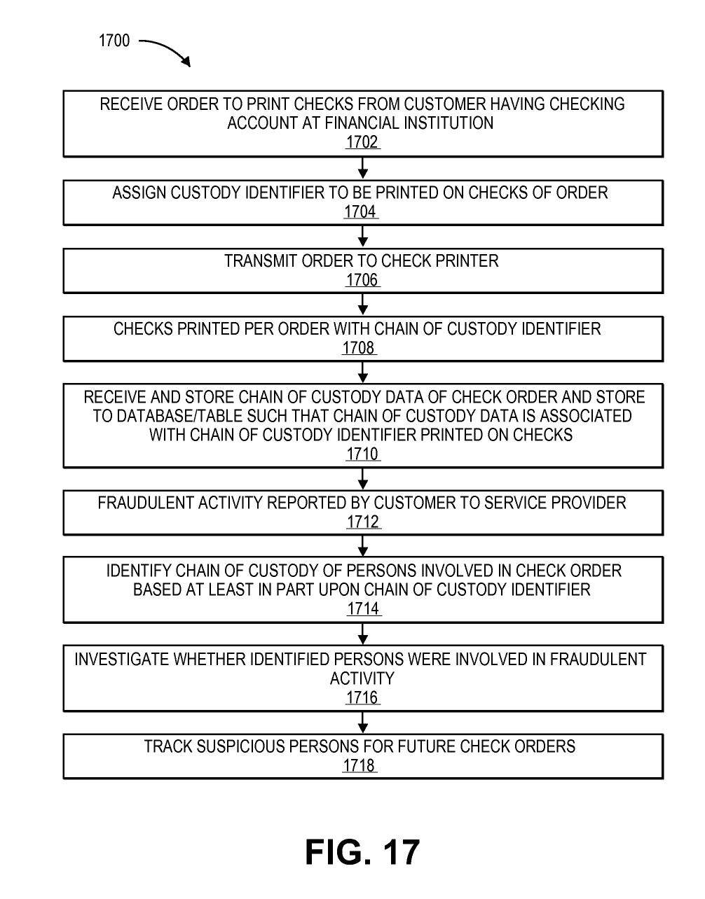

More specifically, referring to FIG. 17, one method 1700 for protecting against check fraud using a chain of custody identifier or indicator 310 comprises, at 1702, receiving an order 251 to print checks 221 from customer 220 having checking account 211 at FI 210. At 1704, service provider 230 or printer 240 assigns or selects a chain of custody indicator 310 to be printed on checks 221. According to embodiments, different checking accounts, orders, account numbers and/or customers can be associated with respective custody indicators 310. If custody indicator 310 is selected by printer 240, printer 240 can inform service provider 230 of the selected custody indicator 310.

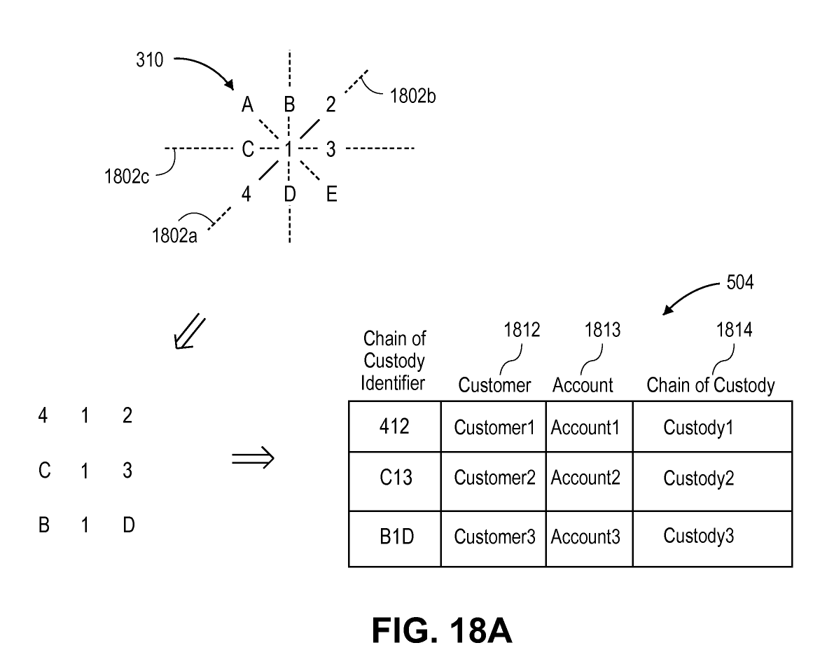

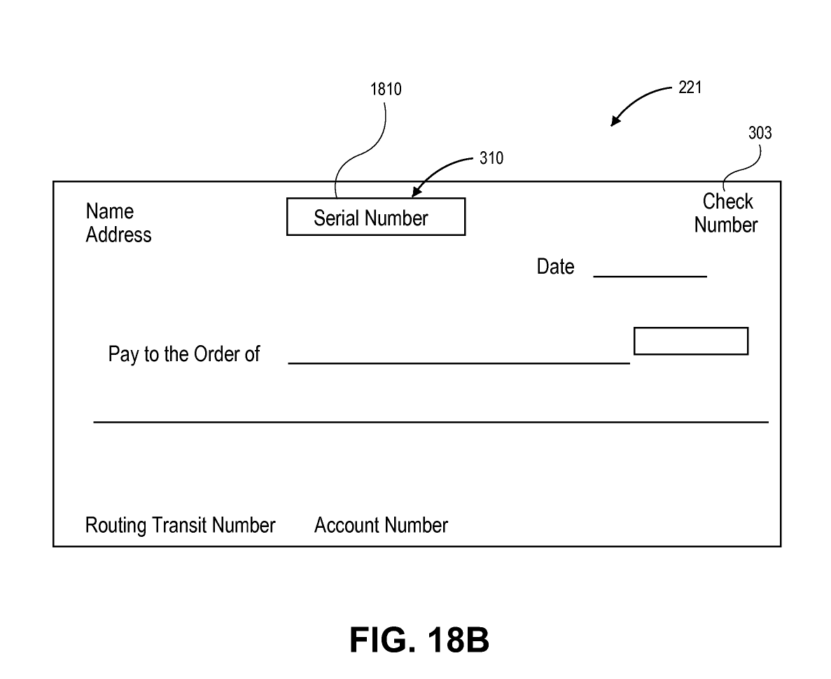

For example, each order 251 of checks may have a different, unique custody indicator 310 such that each check 221 of an order 251 has the same custody indicator 310. In one embodiment, custody indicator 310 is used as pointer, search term or key 1811 to locate chain of custody data 1816 within a table or database 504 that includes respective customer 1812, account 1814 and chain of custody 1816 data. In another embodiment, with reference to FIG. 18, the same custody indicator 310 can be decoded in different ways to apply to multiple customers 220 and may include or be an alpha-numeric array 320, letters and/or numbers along different lines 1802 that are used as keys or search terms 1811 for data within a database or table 504 that includes respective customer 1812, account 1814 and chain of custody 1816 data. For example, as shown in FIG. 18, data “4-1-2” along a diagonal line 1802a indicators a first customer 1812, first account 1814, and first chain of custody data 1816, whereas “B-1-D” along the middle vertical line 1802b of the same indicator 320 can be used to look up the same type of data for a different customer, and “C-1-3” along the middle horizontal line 1802c of the same array indicator 320 can be used to look up the same type of data for a different customer. It will be understood that various identifiers or indicators 310 in the form of letters and/or numbers, which may be structured as arrays of different numbers of elements and shapes/sizes, can be encoded and decoded with customer, account and/or chain of custody data.

Referring again to FIG. 17, at 1706, order 251 is transmitted to printer 240 together with other check/account information and indicator 310 that was assigned or selected, if printer 240 does not select or assign indicator 310. At 1708, checks 211 are printed per order 251 and with custody indicator 310, and at 1710, service provider 230 receives chain of custody data 1816 of the order of checks 211. Check fraud program 506 or another program is used to receive and store chain of custody data 1816 to database 504 such that upon entering, knowing or searching for a key or term such as a customer 230 name or chain of custody indicator 310, related chain of custody data 1816 for that order 512 is located.

Thus, at 1712, if fraudulent activity 502 is reported by customer 220 to service provider 230, at 1714, chain of custody indicator 310 of check 211 involved in fraudulent activity 502 can be identified, database 504 can be searched to identify chain of custody 1816 of persons involved in processing that specific order 251 such that a check fraud investigation can include individual persons having a role in ordering, printing and/or shipping specific checks 221 at 1716. Further, in the event that an investigation determines that there are concerns about a selected individual within the chain of custody, that individual can be monitored more closely for fraud in future check printing orders 251.

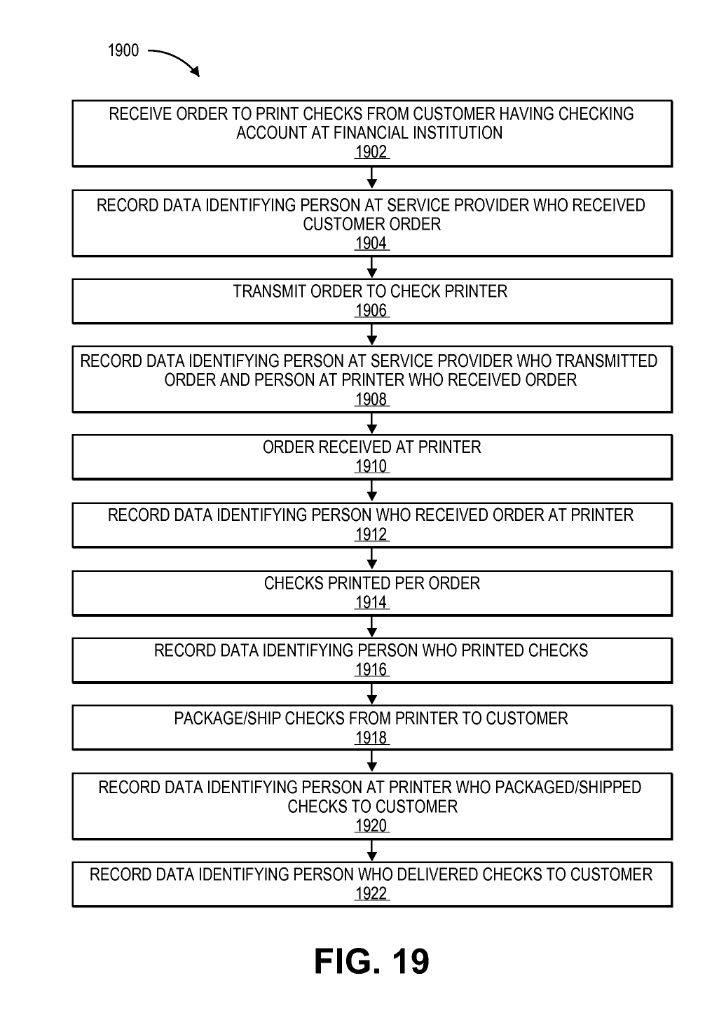

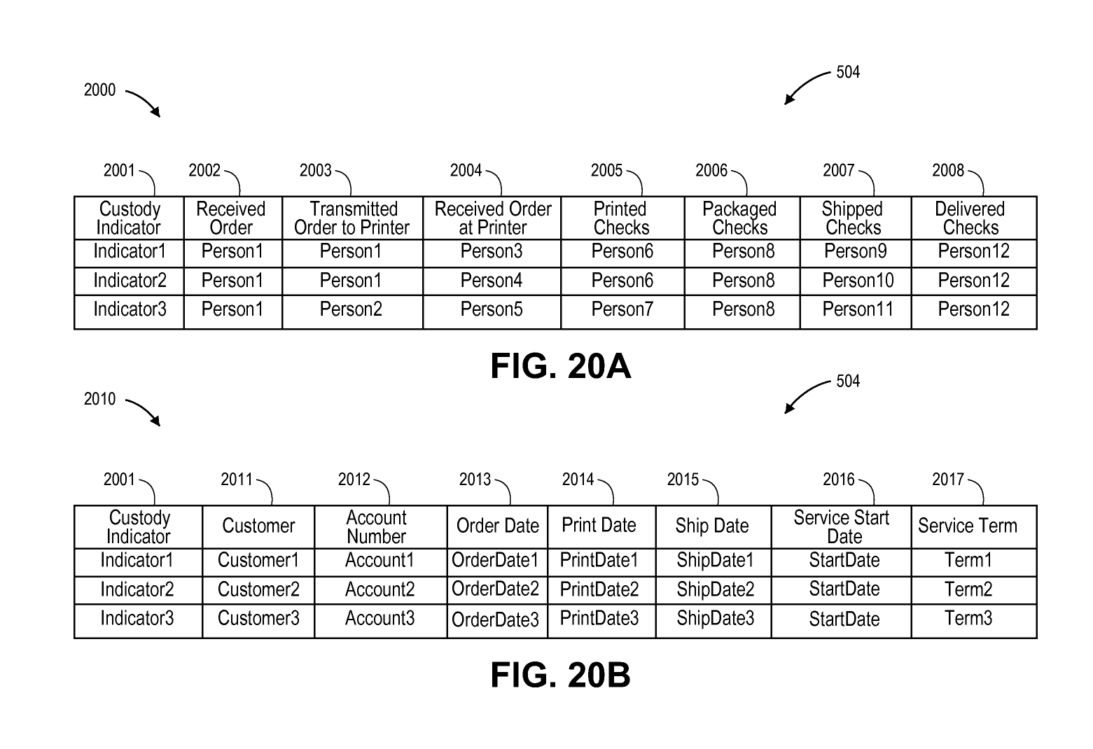

FIGS. 19 and 20A-B illustrate one example of how embodiments may be implemented to track and store chain of custody data 1816 using chain of custody indicator 310 printed on subject check 211 or by decoding chain of custody indicator 310 (an example of which was described above with reference to FIG. 18). Referring to FIG. 19, in a method 1900 according to one embodiment, at 1902, service provider 230 receives from customer 220 an order 251 for printed checks 221. At 1904, the person who received order 251, whether an on-line, phone or mail order, is identified, and that person's identification 2010 is stored in database 504 of service provider 230 computer as one or more tables 2000, 2010 shown in FIGS. 20A-B. This may be done by faxing, reading or scanning chain of custody indicator 310 of order 251 paperwork, which is then transmitted from the fax machine, scanner or reader to database 504. Chain of custody indicator 310 may also be selected by the person taking order 251. With the chain of custody indicator 310 utilized, whether numeric, alpha-numeric, a symbol, color, barcode, matrix or combinations or arrays of such attributes, database 504 includes chain of custody indicator data 2001 and identification 2002 of the person who first received and processed order 251.

At 1906, order 251 data is transmitted from service provider 230 to printer 240, e.g., from a service provider computer to a check printer computer via a network. At 1908, the identity 2003 of the person transmitting order 251 to printer 240 is recorded to database 504 in a similar manner. Thus, with embodiments, chain of custody data 1816 of order 251 can be recorded even before checks 221 have been printed.

At 1910, printer 240 receives order 251, and at 1912, the identity 2004 of the person who receives the order 251 at printer 240 is recorded to database 504 in a similar manner. At 1914, checks 221 are printed per order 251, and at 1916, data of the identification 2005 of the person who printed checks 221, e.g., the person who actually operated the printing machine, is recorded to database 504 in a similar manner.

At 1918, printed checks 221 are packaged and shipped from printer 240 to customer 220 on behalf of service provider 230. At 1920, data 2006, 2007 identifying the person(s) who packaged/shipped checks 221 is recorded to database 504. At 1922, data 2008 identifying the person who delivered the package including checks 221 to customer 220 can also be recorded to the database 504 (e.g., a driver of FEDERAL EXPRESS or UPS).

Thus, as described above and as generally illustrated in FIG. 20A, chain of custody indicator 310 can be used as a tracking mechanism to record chain of custody data 1816, which may include one or more or combinations of specific people at service provider 230 involved in receiving the order from customer 220 and transmitting the order to printer 240, and specific people at printer 240 involved in receiving the order and printing, packaging and shipping the checks, as reflected in columns 2002-2008. Further, as shown in FIG. 20B, chain of custody indicator 310 (2001 in FIGS. 20A-B) may also be used to locate data in columns 2011-2017 related to customer 220 identification, order date, print date, ship date, service 232 start date, service 232 term, and other data may also be stored in database 504 according to custody indicator 310 or other data identifying the customer, account or checks. Given the manner in which embodiments are structured and utilized, chain of custody indicator 310 is not used to determine whether a check is covered by a check fraud protection service since, as disclosed above, embodiments are configured to determining whether a check is covered or enrolled in service 232 without any indicator printed on a check.

Further, according to one embodiment, the chain of custody indicator 310 is a serial number 1810 or other code, which may be in numeric form or encoded as a barcode or matrix. In this embodiment, each check is printed with respective different serial numbers 1810 which, for example, may be scanned or read while being printed and stored to database 504. Serial numbers 1810 are not check numbers 303 and are not used to determine whether check 221 is covered by check fraud protection service 232. In one embodiment, checks 221 are printed with sequential serial numbers 1810. Thus, upon printing, database 504 includes a record of each serial number 1810 of each check 221 that was printed. This allows chain of custody to be tracked on a check-by-check basis. Further, another chain of custody indicator 1810 may be generated to apply to a particular box or order of checks 211 such that embodiments provide for multi-dimensional and more robust chain of custody tracking by being able to track individual checks 221 as well as orders or collections of checks 221.

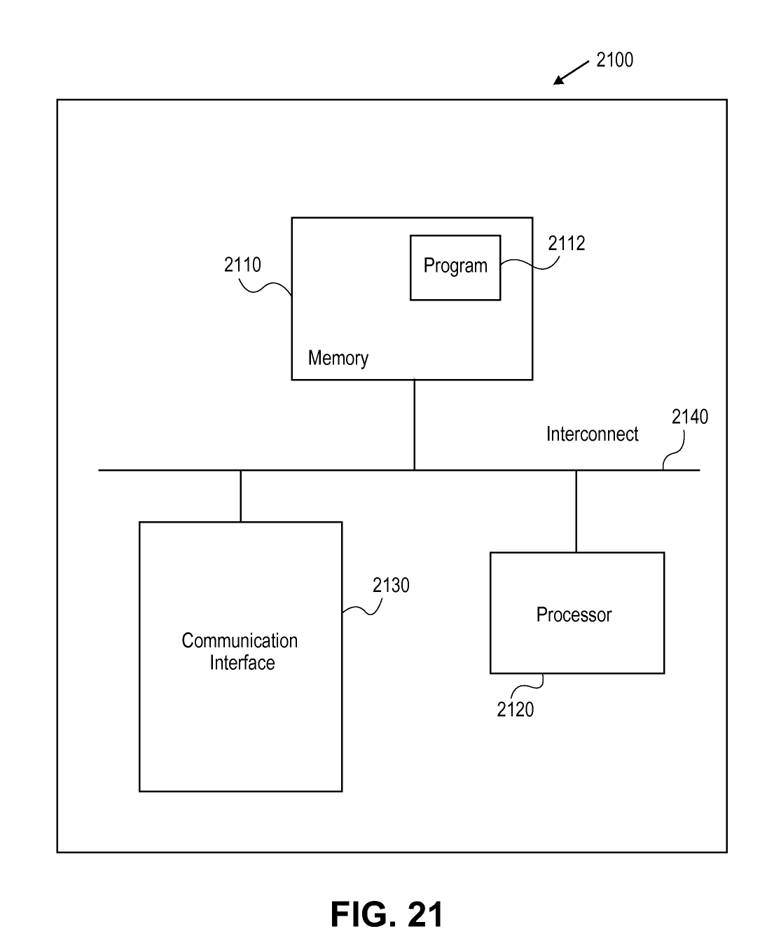

FIG. 21 generally illustrates certain components of a computing device 2100 that may be utilized to execute embodiments and that includes a memory 2110, program instructions 2112, a processor or controller 2120 to execute instructions 2112, a network or communications interface 2130, e.g., for communications with a network or interconnect 2140 between such components. The memory 2110 may be or include one or more of cache, RAM, ROM, SRAM, DRAM, RDRAM, EEPROM and other types of volatile or non-volatile memory capable of storing data. The processor unit 2120 may be or include multiple processors, a single threaded processor, a multi-threaded processor, a multi-core processor, or other type of processor capable of processing data. Depending on the particular system component (e.g., whether the component is a computer or a hand held mobile communications device), the interconnect 2140 may include a system bus, LDT, PCI, ISA, or other types of buses, and the communications or network interface may, for example, be an Ethernet interface, a Frame Relay interface, or other interface. The network interface 2130 may be configured to enable a system component to communicate with other system components across a network which may be a wireless or various other networks. It should be noted that one or more components of computing device 2100 may be located remotely and accessed via a network. Accordingly, the system configuration provided in FIG. 21 is provided to generally illustrate how embodiments may be configured and implemented.

Method embodiments or certain steps thereof, some of which may be loaded on certain system components, computers or servers, and others of which may be loaded and executed on other system components, computers or servers, may also be embodied in, or readable from, a tangible medium or computer-readable medium or carrier, e.g., one or more of the fixed and/or removable data storage data devices and/or data communications devices connected to a computer. Carriers may be, for example, magnetic storage medium, optical storage medium and magneto-optical storage medium. Examples of carriers include, but are not limited to, a floppy diskette, a memory stick or a flash drive, CD-R, CD-RW, CD-ROM, DVD-R, DVD-RW, or other carrier now known or later developed capable of storing data. The processor 2120 performs steps or executes program instructions 2112 within memory 2110 and/or embodied on the carrier to implement method embodiments.

Although particular embodiments have been shown and described, it should be understood that the above discussion is not intended to limit the scope of these embodiments. While embodiments and variations of the many aspects of the invention have been disclosed and described herein, such disclosure is provided for purposes of explanation and illustration only. Thus, various changes and modifications may be made without departing from the scope of the claims.

For example, while aspects of embodiments are described as being performed or involving a FI, customer, service provider, printer and insurer, it should be understood that such actions may be computer implemented, and that communications between parties and components may be through one or more networks and combinations of networks including, for example, cellular, wireless and Internet communications involving a Local Area Network (LAN), a Wide Area Network (WAN), Metropolitan Area Network (MAN), a wireless network, other suitable networks capable of transmitting data, or a network may be a combination of such networks or utilize different communication methods or protocols.

Further, it should be understood that the check fraud program executing on a computer of the service provider or on another computer accessible by the service provider computer can be programmed to execute various aspects of embodiments in which determinations are made regarding, e.g., whether a fraud protection service applies, comparisons of fraud protection program start dates and order dates, transmission of reimbursement requests to FI computers, conducting table or database lookups, decoding chain of custody indicator, etc.,

While embodiments are described with reference to a particular customer, it should be understood that embodiments may involve various numbers of customers, FIs, checking accounts, service providers, insurers and check printers. Thus, for example, a customer may receive compensation from one service provider and one insurer, only one service provider, only one insurer or from multiple insurers.

Moreover, while certain embodiments are describe with reference to certain examples of negligence or fault, it will be understood that FI determinations regarding such matters may involve different types of negligence, fault and evidence, including, but not limited to, police reports.

Additionally, while certain embodiments are described with reference to a chain of custody indicator printed on checks, embodiments do not require and do not utilize any printed indicator for determining whether a check is covered by a check fraud protection service, and new checks printed for a new account have no such printed enrollment indicators.

Further, while multiple embodiments and variations of the many aspects of the invention have been disclosed and described herein, such disclosure is provided for purposes of illustration only. Where methods and steps described above indicate certain events occurring in certain order, those of ordinary skill in the art having the benefit of this disclosure would recognize that the ordering of certain steps may be modified and that such modifications are in accordance with the variations of the invention. Additionally, certain of the steps may be performed concurrently in a parallel process as well as performed sequentially. Thus, methods shown in various flow diagrams are not intended to be limited to a particular sequential order, particularly in instances in which certain steps may or may not be performed. Accordingly, embodiments are intended to exemplify alternatives, modifications, and equivalents that may fall within the scope of the claims.

What is claimed is:

1. A check fraud protection method, comprising:
receiving an order to print checks for a customer that has a first checking account at a financial institution;
printing checks for the first checking account per the order;
enrolling checks of the order into a check fraud protection service;
receiving a request from the customer to be reimbursed for fraudulent activity involving a check printed per the order;
determining whether the check is covered by the check fraud protection service; and, if the check is covered by the check fraud protection service,
reimbursing the customer for a difference between a first amount comprising the lesser of a maximum coverage amount and financial loss resulting from the fraudulent activity, and a second amount paid by the financial institution to the customer in response to a claim submitted to the financial institution.

2. The method of claim 1, wherein reimbursement is first requested by the customer directly from the financial institution.

3. The method of claim 1, wherein reimbursement is first requested by the provider of the check fraud protection service on behalf of the customer from the financial institution while the customer retains the exclusive right of recovery from the financial institution.

4. The method of claim 1, the financial institution approving the claim and agreeing to fully compensate the customer.

5. The method of claim 1, the financial institution approving a portion of the claim and agreeing to partially compensate the customer such that the second amount paid by the financial institution is less than first amount, the difference between the first amount and the second amount being paid to the customer by the provider of the check fraud protection service or an insurer of the provider.

6. The method of claim 5, the financial institution approving the portion of the claim due to the financial institution determining that the customer was negligent or at least partially at fault for the fraudulent activity.

7. The method of claim 1, the financial institution denying the claim such that the financial institution makes no payment to the customer, the customer being compensated by the provider of the check fraud protection service or an insurer of the provider.

8. The method of claim 7, the financial institution denying the claim due to the financial institution determining that the customer was negligent or at least partially at fault for the fraudulent activity.

9. The method of claim 1, further comprising:
closing the first checking account;
opening a second checking account; and
printing new checks for the second checking account at no charge to the customer; and
enrolling the new checks into the check fraud protection service.

10. The method of claim 1, the customer retaining the exclusive right of recovery from the financial institution at all times during processing of the claim.

11. The method of claim 10, the claim being processed and resolved with no power of attorney signed by the customer.

12. The method of claim 10, wherein neither the provider nor a printer of the checks has any right at anytime during processing of the claim to any portion of any payment made by the financial institution.

13. The method of claim 1, the provider of the fraud protection service serving as an advisor or consultant to the customer to assist the customer in processing the claim and receiving reimbursement from the financial institution.

14. The method of claim 1, the customer retaining the exclusive right of recovery from the financial institution at all times during processing of the claim.

15. The method of claim 1, the provider automatically enrolling the checks into the fraud protection service such that the customer is not required to separately subscribe to the fraud protection service or pay a service fee in addition to the cost of the checks.

16. The method of claim 1, the printed checks being automatically enrolled in the fraud protection service for a pre-determined time from the order date and for a pre-determined maximum coverage amount.

17. A check fraud protection method, comprising:
receiving an order to print checks for a customer who has a first checking account at a financial institution;
printing checks for the first checking account per the order; and
automatically enrolling the order of printed checks into a fraud protection service, each check of the order being covered by the fraud protection service without requiring the customer to separately subscribe to the fraud protection service or pay an additional fee relative to a cost of the ordered checks.

18. The method of claim 17, further comprising:
receiving a request from the customer requesting reimbursement for fraudulent activity involving a check printed per the order;
determining whether the check is covered by the check fraud protection service; and, if the check is covered by the check fraud protection service,
assisting the customer with a claim for reimbursement to the financial institution while the customer retains the exclusive right of reimbursement from the financial institution at all times during processing of the claim.

19. The method of claim 18, wherein reimbursement is first requested by the customer directly from the financial institution.

20. The method of claim 19, the financial institution approving a portion of the claim and agreeing to partially compensate the customer such that the second amount paid by the financial institution is less than first amount, the difference between the first amount and the second amount being paid to the customer by the provider of the check fraud protection service or an insurer of the provider.

21. The method of claim 19, the financial institution approving only a portion of the claim due to the financial institution determining that the customer was negligent or at least partially at fault for the fraudulent activity.

22. The method of claim 19, the financial institution denying the claim such that the financial institution makes no payment to the customer, the customer being compensated by the provider of the check fraud protection service or an insurer of the provider.

23. The method of claim 22, the financial institution denying the claim due to the financial institution determining that the customer was negligent or at least partially at fault for the fraudulent activity.

24. The method of claim 18, the customer retaining the exclusive right of recovery from the financial institution at all times during processing of the claim.

25. The method of claim 18, the claim being processed and resolved with no power of attorney signed by the customer.

26. The method of claim 18, wherein neither the provider nor a printer of the checks has any right at anytime during processing of the claim to any portion of any payment made by the financial institution.

27. The method of claim 18, the provider of the fraud protection service serving as an advisor or consultant to the customer to assist the customer in processing the claim and receiving reimbursement from the financial institution.

28. The method of claim 18, the provider automatically enrolling the checks into the fraud protection service such that the customer is not required to separately subscribe to the fraud protection service or pay a service fee in addition to the cost of the checks.

29. A check fraud protection method, comprising:
receiving an order to print checks for a customer that has a first checking account at a financial institution;
printing checks for the first checking account per the order;
automatically enrolling checks of the order into a check fraud protection service without requiring the customer to separately subscribe to the fraud protection service;
receiving a request from the customer to be reimbursed for fraudulent activity involving a check printed per the order;
determining whether the check is covered by the check fraud protection service;
determining whether the fraudulent activity involved financial loss to the customer; and
if the fraudulent activity did not involve loss to the customer, closing the first checking account, opening a second checking account, and printing new checks for the second checking account at no charge to the customer, and automatically enrolling the new checks into the check fraud protection service; and
if the fraudulent activity involved financial loss to the customer, assisting the customer with a claim for reimbursement to the financial institution while the customer retains the exclusive right of reimbursement from the financial institution at all times during processing of the claim.

30. The method of claim 29, the financial institution approving the claim involving financial loss and agreeing to fully compensate the customer.

31. The method of claim 29, the financial institution approving a portion of the claim involving financial loss and agreeing to partially compensate the customer, wherein the provider of the check fraud protection service or an insurer of the provider also compensates the customer.

32. The method of claim 31, the financial institution approving only a portion of the claim due to the financial institution determining that the customer was negligent or at least partially at fault for the fraudulent activity.

33. The method of claim 29, the financial institution denying the claim such that the financial institution makes no payment to the customer, wherein the provider of the check fraud protection service or an insurer of the provider also compensates the customer.

34. The method of claim 33, the financial institution denying the claim due to the financial institution determining that the customer was negligent or at least partially at fault for the fraudulent activity.

35. The method of claim 29, the claim being processed and resolved with no power of attorney signed by the customer.

36. The method of claim 29, wherein neither the provider nor a printer of the checks has any right at anytime during processing of the claim to any portion of any payment made by the financial institution.

37. The method of claim 29, the provider of the fraud protection service serving as an advisor or consultant to the customer to assist the customer in processing the claim and receiving reimbursement from the financial institution.

38. A check fraud protection method, comprising:
receiving an order to print checks for a customer that has a first checking account at a financial institution;
printing checks for the first checking account per the order;
automatically enrolling the order of printed checks into a fraud protection service, each check of the order being covered by the fraud protection service without requiring the customer to separately subscribe to the fraud protection service or pay an additional fee relative to a cost of the ordered checks;
receiving a request from the customer to be reimbursed for fraudulent activity involving a check printed per the order;
determining whether the check is covered by the check fraud protection service; and, if the check is covered by the check fraud protection service, if the check is covered by the check fraud protection service, determining whether the fraudulent activity involved financial loss to the customer;
if the fraudulent activity did not involve loss to the customer, closing the first checking account, opening a second checking account, printing new checks for the second checking account at no charge to the customer, and automatically enrolling the new checks into the check fraud protection service;
if the fraudulent activity involved financial loss to the customer, assisting the customer with a claim for reimbursement to the financial institution while the customer is not required to execute a power of attorney and retains the exclusive right of reimbursement from the financial institution at all times during processing of the claim;
if the customer is not fully compensated by the financial institution, further compensating the customer a difference between a first amount comprising the lesser of a maximum coverage amount and financial loss resulting from the fraudulent activity, and a second amount paid by the financial institution to the customer.

39. A check fraud protection method, comprising:
receiving an order to print checks for a customer who has a first checking account at a financial institution;
printing checks for the first checking account per the order; and
enrolling the order of printed checks into a fraud protection service, each check of the order being covered by the fraud protection service without requiring the customer to separately subscribe to the fraud protection service;
receiving a request from the customer to be reimbursed for fraudulent activity involving a check printed per the order;
determining whether the check is covered by the check fraud protection service; and, if the check is covered by the check fraud protection service, and if the check is covered,
serving as an advisor or consultant to the customer to assist the customer in processing a claim for reimbursement submitted to the financial institution and receiving reimbursement from the financial institution while the customer retains the exclusive right of recover from the financial institution.
